(19) United States
(12) Patent Application Publication
(10) Pub. No.: US 2025/0388791 A1
(43) Pub. Date: Dec. 25, 2025

(54) CYCLIC ACETAL CROSSLINKER AND SOLVENT FOR FORMALDEHYDE RESIN

(71) Applicant: Hexion Inc., Columbus, OH (US)

(72) Inventors: J. Taylor Goodrich, Creswell, OR (US); Daniel Pacheco, Eugene, OR (US); Gregory D. Briner, Springfield, OR (US); Sean Elliott Manji, Springfield, OR (US); Sejal Sanjeev Sheth, Springfield, OR (US); Joann Michelle Sutyak, Eugene, OR (US); Bidhya Kunwar, Eugene, OR (US); Ryan W. Clarke, Springfield, OR (US)

(73) Assignee: Hexion Inc., Columbus, OH (US)

(21) Appl. No.: 19/243,372

(22) Filed: Jun. 19, 2025

Related U.S. Application Data
(60) Provisional application No. 63/662,106, filed on Jun. 20, 2024.
(60) Provisional application No. 63/663,374, filed on Jun. 24, 2024.

(51) Int. Cl. C09J 161/06; C09J 11/06

(52) U.S. Cl. CPC C09J 161/06; C09J 11/06

(57) ABSTRACT

An adhesive composition comprising a formaldehyde binder resin and a monocyclic or bicyclic acetal crosslinking agent is disclosed. The adhesive composition may be in the form of a liquid, having a viscosity at 25° C. of 100 to 10,000 cP, or the adhesive composition may be in the form of a solid. The adhesive composition includes low-to-no VOCs or formaldehyde emissions, has improved shelf-life stability, and desirable cure conditions.

### RELATED APPLICATIONS

This application claims priority to and any benefit of U.S. Provisional Application No. 63/663,374, filed Jun. 24, 2024 and U.S. Provisional Application No. 63/662,106, filed Jun. 20, 2024, the content of each being incorporated herein by reference in its entirety.

### FIELD

The invention is directed to an adhesive composition that includes a formaldehyde binder resin and a mono-or bicyclic acetal crosslinking agent and methods of manufacturing the adhesive composition. The invention further relates to use of the adhesive composition to manufacture composite products, and the composite products formed therefrom.

### BACKGROUND

Composite materials, such as wood composite materials, are highly desirable building materials due to their lightweight, high stiffness nature and due to the ability to tailor their properties to meet specific applications. These wood composite materials may include, for example, particle board, flake board, hard board and medium density fiber board (“MDF”), and the like. The wood composites generally utilize adhesives to bind the wood materials and maintain the wood fibers or particles in a solid form.

Common adhesives for use in such composites include urea-formaldehyde or phenol-formaldehyde resins. Phenol-formaldehyde binders are most widely used, due to its good mechanical strength properties and moisture resistance. Phenol-formaldehyde binders, and particularly novolac resins, are often cured in the presence of a hexamethylenetetramine crosslinking agent and polar organic solvents. Such solvents, however, often include high VOC content and the resulting adhesive compositions have relatively low shelf-life stability.

### SUMMARY

The invention is directed to an adhesive composition that includes a formaldehyde binder resin and a monocyclic or bicyclic acetal crosslinking agent. The adhesive composition may be in the form of a liquid, having a viscosity at 25° C. of 100 to 10,000 cP, or the adhesive composition may be in the form of a solid. The formaldehyde binder resin and mono or bicyclic acetal crosslinking agent are present in the adhesive composition in a weight ratio of about 5:1 to about 0.25:2.5.

The adhesive composition may optionally include a processing aid selected from the group consisting of water, methanol, ethanol, glycerin, ethylene glycol, propylene glycol, dihydrolevoglucosenone, levoglucosenone, dipropylene glycol dibenzoate, diethylene glycol dibenzoate, carbonate-based solvents, such as propylene carbonate and glycerol carbonate, esterified solvents, such as triethyl citrate, and the like, and combinations thereof. If present, the processing aid is included in the adhesive composition in an amount from 0.1 wt. % to 40 wt. %, based on a total weight of the adhesive composition.

The formaldehyde binder resin may comprise a phenolic formaldehyde (PF) binder resin, phenol-formaldehyde polymer containing phenolic substitutes, resorcinol-formaldehyde binder resin, urea-formaldehyde (UF) binder resin, melamine-formaldehyde (MF) binder resin, or combinations thereof. Particularly, the formaldehyde binder resin may comprise a novolac resin.

The cyclic acetal crosslinking agent may comprise any of 1,3-dioxane, 1,3-dioxolane, 1,3-dioxepane, 1,3,6,7-tetraoxyacycloundecane, 1,3,5-trioxane, diformylxylose, diformyl pentaerythritol (also referred to as pentaerythritol bisformal, pentaerythritol cyclic diformal, etc.), levoglucosenone, dihydrolevoglucosenone, diformyl glucose, glycerol formal, 2,6-dioxabicyclo[2.2.1]heptane, 6,8-dioxabicyclo[3.2.1]octane, 1,6-anhydro-β-D-glucopyranoze, or mixtures thereof.

Optionally, the adhesive composition may further comprise an acid catalyst, which preferably has a pKa no greater than 6. Exemplary acid catalysts include sulfuric acid, formic acid, glyoxylic acid, citric acid, hydrochloric acid, phosphoric acid, alkanesulfonic acids, such as methanesulfonic acid or p-toluenesulfonic acid, benzoic acid, Lewis acids, such as aluminum chloride and zinc chloride, or combinations thereof.

The adhesive composition has an improved curing temperature and is capable of curing at temperatures as low as 100° C., preferably in a curing temperature range of 100° C. to 150° C.

Further aspects of the present invention are directed to a method of manufacturing the liquid adhesive composition. The method includes dissolving a formaldehyde binder powder in a liquid cyclic acetal crosslinking agent, optionally in the presence of a processing aid. The liquid adhesive composition is then cooled to room temperature. Optionally, an acid catalyst may be added to the liquid adhesive composition after the step of cooling. The resulting liquid adhesive composition has a viscosity at 25° C. between 100 and 10,000 cPs.

Yet further aspects of the present invention are directed to a method of manufacturing the adhesive composition that includes blending a formaldehyde binder powder with a cyclic acetal crosslinking agent, forming a blended powder adhesive precursor. The blended powder adhesive precursor may then be heated to a temperature sufficient to melt the blended powder, optionally in the presence of a processing aid. One melted and mixed with the processing aid, the mixture may be cooled to room temperature. Optionally, an acid catalyst may be added to the adhesive composition after cooling.

The adhesive composition, whether in a solid or liquid form, may be provided as a system comprising an adhesive composition and an acid catalyst. The adhesive composition includes the formaldehyde binder resin and the cyclic acetal crosslinking agent, and is packaged separately from the acid catalyst or is separated therefrom within a single packaging.

The invention is further directed to adhesive compositions including eutectic mixtures of novolac resin and a cyclic acetal crosslinking agent selected from the group consisting of diformylxylose, diformyl pentaerythritol, or mixtures thereof. Such eutectic mixtures may further include an isocyanate component, such as pMDI. It was discovered that eutectic mixtures incorporating an isocyanate, such as pMDI, may be cured without the use of an acid catalyst.

Aspects of the invention further relate to methods of manufacturing composite articles along with the composite articles formed therefrom. Certain methods may include applying the adhesive composition to a first substrate, forming a coated substrate, and then applying pressure and heat to the coated substrate at a temperature and pressure sufficient to initiate curing of the adhesive composition and for a sufficient amount of time to complete curing, forming the composite article. Such composite articles may include plywood, a laminated veneer layer (LVL) product, laminated glulam beam, mass timber, oriented strand board (OSB), cross-laminated timber (CLT), particle board, or medium density fiberboard (MDF).

Other methods of making composite articles include saturating a fibrous substrate, such as a fiberglass or paper substrate, with the adhesive composition, forming a saturated fibrous substrate and then allowing the saturated fibrous substrate to cure and thereby form the composite article. Such composite articles may comprise medium density overlay (MDO), high density overlay (HDO), an overlaid weather barrier, high pressure laminates (HPL), or thermally fused laminates (TFL).

Alternatively, the adhesive composition may be blended with a lignocellulosic material, such as wood chips, wood fiber, wood powder, or wood flour. The cellulosic material blended with the adhesive composition may then be pressed in the presence of heat at a temperature and pressure sufficient to initiate curing of the adhesive composition and for a sufficient amount of time to complete curing and thereby form the composite article. Such composite articles may include, for example, particle board, medium density fiberboard (MDF), or oriented strandboard (OSB).

Yet further composite articles may be made by pressure infusing lumber or wood veneer with the adhesive composition and then B-staging the infused lumber or wood veneer in pre-cure for a period of time. The pre-cured lumber or wood veneer may then be heated to thermally cure the infused adhesive composition and thereby form the composite article. Such composite articles may include, for example, pressure treated lumber or pressure treated veneer.

Numerous other aspects, advantages, and/or features of the general inventive concepts will become more readily apparent from the following detailed description of exemplary embodiments and from the accompanying drawings being submitted herewith.

### BRIEF DESCRIPTION OF THE DRAWINGS

FIG. 1 graphically illustrates differential scanning calorimetry (DSC) for exemplary liquid composition adhesive Examples 4-1 and 4-2.

FIG. 2 graphically illustrates oscillatory rheology testing at 100° C. for Example 4-2.

FIG. 3 graphically illustrates oscillatory rheology testing at 125° C. for Example 4-2.

FIG. 4A graphically illustrates oscillatory rheology testing at 177° C. for Example 7.1.

FIG. 4B graphically illustrates DSC testing at 177° C. for Example 7.1.

FIGS. 5A 5B graphically illustrate the DSC and DMA measurements taken on B-staged paper of Example 7.2.

FIG. 6A graphically illustrates oscillatory rheology testing at 150° C. for Example 7.3.

FIGS. 6B and 6C graphically illustrate the DSC and DMA measurements taken on B-Staged paper of Example 7.3.

FIG. 7A graphically illustrates oscillatory rheology testing at 150° C. for Example 7.4.

FIGS. 7B and 7C graphically illustrate the illustrates the DSC plots of the saturated paper samples of Example 7.4, cured for 1.5 min.

FIG. 8 graphically illustrates oscillatory rheology testing for Example 8.

FIG. 9 graphically illustrates oscillatory rheology testing at 150° C. for Example 9.

FIG. 10 graphically illustrates oscillatory rheology testing at 150° C. for Example 10.

### DETAILED DESCRIPTION

The invention is directed to an adhesive composition that includes a formaldehyde binder resin and a mono or bicyclic acetal crosslinking agent and methods of manufacturing the adhesive composition. Although the cyclic acetal is described herein as a crosslinking agent, it should be appreciated that the particular cyclic acetals also function to solubilize the resin. Therefore, the cyclic acetal crosslinking agent can also be characterized as a reactive solvent in the adhesive composition. The adhesive composition is used to manufacture composite products, and therefore, the invention further relates to composite products and method of manufacturing such products using the adhesive composition disclosed herein. While the following disclosure describes certain aspects of the adhesive composition, methods of manufacturing, and composite products in detail, the present disclosure is to be considered exemplary and is not intended to be limited to the disclosed aspects.

Unless otherwise specified, the term “cyclic acetal” refers to a compound having at least one cyclic acetal functional group where the acetal carbon and at least one oxygen are in a ring structure. The term “monocyclic acetal” refers to cyclic acetal compounds having a single ring structure. The term “bicyclic acetal” refers to cyclic acetal compounds having two rings that are connected by at least one carbon atom, with at least one ring being an acetal ring.

Unless otherwise specified, the term “binder resin” refers to a cross-linkable thermosetting composition. Thus, the term “formaldehyde binder resin” refers to a cross-linkable thermosetting resin formed with formaldehyde.

Unless otherwise specified, all references to viscosity were measured by a rheometer at 25° C. with 40 mm parallel plates, a 0.6 mm gap, and a 0.33 rad/s velocity.

Unless otherwise specified, all references to pressure in pounds per square inch (psi) refer to psi absolute or in other words psia.

The terminology as set forth herein is for description only and should not be construed as limiting the disclosure as a whole. All references to singular characteristics or limitations of the present disclosure shall include the corresponding plural characteristic or limitation, and vice versa, unless otherwise specified or clearly implied to the contrary by the context in which the reference is made. Unless otherwise specified, “a,” “an,” “the,” and “at least one” are used interchangeably. Furthermore, as used in the description and the appended claims, the singular forms “a,” “an,” and “the” are inclusive of their plural forms, unless the context clearly indicates otherwise.

To the extent that the term “includes” or “including” is used in the description or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When intending to indicate “only A or B but not both” then the term “only A or B but not both” will be employed. Thus, use of the term “or” herein is the inclusive, and not the exclusive use.

All combinations of method or process steps as used herein can be performed in any order, unless otherwise specified or clearly implied to the contrary by the context in which the referenced combination is made.

Unless otherwise indicated, all numbers expressing quantities of ingredients, chemical and molecular properties, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present exemplary aspects. At the very least, each numerical parameter should be construed in light of the number of significant digits and ordinary rounding approaches.

All ranges and parameters, including but not limited to percentages, parts, and ratios, disclosed herein are understood to encompass any and all sub-ranges assumed and subsumed therein, and every number between the endpoints. For example, a stated range of “1 to 10” should be considered to include any and all sub-ranges beginning with a minimum value of 1 or more and ending with a maximum value of 10 or less (e.g., 1 to 6.1, or 2.3 to 9.4), and to each integer (1, 2, 3, 4, 5, 6, 7, 8, 9, and 10) contained within the range.

The methods of the invention can comprise, consist of, or consist essentially of the essential elements of the disclosure as described herein, as well as any additional or optional element described herein, or which is otherwise useful in adhesive compositions and composite products produced therefrom.

As mentioned above, aspects of the invention are directed to an adhesive composition that includes a formaldehyde binder resin and a mono or bicyclic acetal crosslinker.

The adhesive composition comprises a formaldehyde binder resin component. The formaldehyde binder resin may comprise any of a phenolic formaldehyde (PF) binder resin, phenol-formaldehyde polymer containing phenolic substitutes, resorcinol-formaldehyde binder resin, urea-formaldehyde (UF) binder resin, melamine-formaldehyde (MF) binder resin, or mixtures thereof.

In certain aspects, the formaldehyde binder resin comprises a phenolic formaldehyde binder resin. As used herein, the terms “phenolic formaldehyde” and “phenolic formaldehyde resin” refer to the condensation product and/or pre-condensate of a phenol compound and formaldehyde. The phenolic formaldehyde binder resin may include a phenol-formaldehyde resin, a phenol-formaldehyde resole resin, a phenol-resorcinol formaldehyde resin, resorcinol-formaldehyde resin, an emulsified phenol formaldehyde resin, or combinations thereof.

When the molar ratio of formaldehyde to phenol is less than one (aldehyde: phenol <1) and reacted in the presence of an acid catalyst, the phenolic formaldehyde binder is considered a novolac binder and may be represented by the following structure:

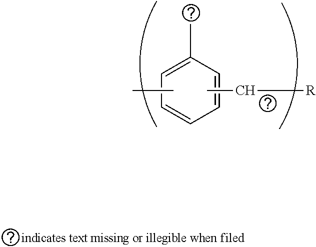

where R═OH or comprises the following structure:

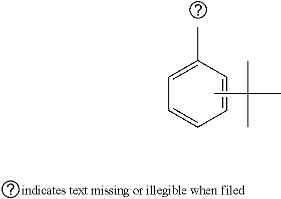

Novolacs suitable for the present invention (or in accordance with the present disclosure) include low molecular weight phenol-formaldehyde resins that may have molecular weights in the range of 200 g/mol to 250,000 g/mol. The acid catalyst may comprise, for example, sulfuric acid, hydrochloric acid, oxalic acid, and the like. Suitable novolacs may further include high-ortho novolacs, which are characterized by a high degree of othro-ortho linkages. In some aspects, the novolac resin may include a non-phenol novolac, which includes aromatic compounds such as cresols or bisphenols, rather than phenol. Novolacs are not self-cross-linkable, but may be converted into cured resins by a heated reaction with a suitable crosslinking agent.

Alternatively, the formaldehyde binder resin may comprise a phenol-formaldehyde resole resin, which is synthesized from reacting phenol and formaldehyde with an alkaline catalyst (i.e., NaOH) under basic conditions and with a molar excess of formaldehyde.

Exemplary phenol-formaldehyde resole resins include phenol-resorcinol-formaldehyde resin, resorcinol-formaldehyde, and emulsified phenol-formaldehyde resin with an aldehyde: phenol mole ratio ≥1.0, such as at least 1:1, or between 1:0.99 to 3:1 that is acid or base catalyzed. The phenol-formaldehyde resole resin can be modified with a different hydroxy aromatic including but not limited to resorcinol, 1-aminophenol, 2-aminophenol, 3-aminophenol, catechol, Honeyol, Bisphenol A, tannin, condensed tannins, lignin, or combinations thereof.

Alternatively, the formaldehyde binder resin may comprise an amino-aldehyde resin, such as urea-formaldehyde, melamine-urea-formaldehyde, melamine-formaldehyde, alkoxylated melamine-formaldehyde, and the like. In the case of urea-formaldehyde or a melamine-urea-formaldehyde binder resins, the aldehyde: amino mole ratio is from 0.25:4.0 to 4.5:1, including, for example, mole ratios from 0.25:3.5, 0.25:3.25, 0.3:3.0, 0.3:2.75, 0.3:2.5, 0.4:2.0, 0.4:1.75, 0.5:3.0, 0.5:2.0, 0.5:1.0, 1.0:1.0, including all endpoints and subranges therebetween. In the case of a melamine-formaldehyde resin or alkoxylated melamine-formaldehyde resin, the aldehyde: amino mole ratio is from 0.25:1.0 to 8.0:1.0, including, for example, from 0.25:0.95, 0.25:0.80, 0.25:0.75, 0.25:0.5, 0.25:0.25, 0.5:0.25, 0.75:0.25, 1.0:0.25, 1.25:0.25, 1.5:0.25, 1.75:0.25, and 2.0:0.25, including all endpoints and subranges therebetween.

The formaldehyde binder resin may be a pure resin, or may include up to 80 wt. % of “additional components” as defined below. The formaldehyde binder resin can be acidic with a pH range less than 7, or may be neutralized through the thermal decomposition of acid and/or neutralized with a caustic source having a pH range of 6.5-11.9.

The formaldehyde binder resin may be present in the adhesive composition in an amount ranging from 1 wt. % to 99 wt. % based on the total weight solids of the composition, including, for example from 5 wt. % to 90 wt. %, from 8 wt. % to 85 wt. %, from 10 wt. % to 80 wt. %, from 15 wt. % to 75 wt. %, from 17 wt. % to 70 wt. %, from 20 wt. % to 65 wt. %, from 22 wt. % to 60 wt. %, from 25 wt. % to 55 wt. %, from 28 wt. % to 50 wt. %, and from 30 wt. % to 45 wt. %, including any endpoints and subranges therebetween. In certain aspects, the adhesive composition may include at least 20 wt. % of the formaldehyde binder resin, based on the total weight solids of the composition.

Conventional formaldehyde binder resins, and particularly novolac resins, are used in the solid form as powder coatings or as a liquid after being dissolved in polar organic solvents. Some polar organic solvents, however, tend to have a high concentration of volatile organic compounds (“VOCs”). It has been surprisingly discovered that the use of a cyclic acetal crosslinking agent has a dual function of not only crosslinking the formaldehyde binder resin, but also acting as a solvent for the solid powder formaldehyde resins, such as novolac resins. When in the liquid state, the cyclic acetal crosslinking agents can solvate the binder resin to a workable viscosity, while also functioning as a crosslinker, either becoming part of the crosslinked polymer or decomposing into a non-hazardous sugar during cure. The cyclic acetal crosslinking agents improve over conventional crosslinking agents, such as hexamethylenetetramine, providing compositions with higher shelf-life stability and an improved viscosity, due to the dual function as a solvent. Until now, such cyclic acetals were not known to solvate formaldehyde resins and form eutectic mixtures. Eutectic mixtures include mixtures of two or more compounds, where the melting point of the mixture is lower than the melting points of the individual compounds.

Accordingly, the adhesive composition further includes a cyclic acetal crosslinking agent. Cyclic acetals may be formed by the acid-catalyzed reaction of an aldehyde or ketone with a diol, such as ethylene glycol. The cyclic acetal may comprise a single cyclic acetal functional group (a monocyclic acetal) or may comprise a bicyclic acetal. The bicyclic acetal includes a two-ring structure joined at a central carbon atom with at least two oxygen atoms bonded to a substituted or unsubstituted alkyl group. The term “cyclic acetal crosslinking agent” may be used interchangeably herein with “mono or bicyclic acetal crosslinking agent,” and it should be appreciated that when describing the crosslinking agent of the subject invention, the cyclic acetal is a mono- or bicyclic acetal.

Exemplary cyclic acetals include 1,3-dioxane, 1,3-dioxolane, 1,3-dioxepane, 1,3,6,7-tetraoxyacycloundecane, 1,3,5-trioxane, diformylxylose (“DFX”), diformyl pentaerythritol (“DFP”) (also referred to as pentaerythritol bisformal, pentaerythritol cyclic diformal, etc.), dihydrolevoglucosenone, levoglucosenone, diformyl glucose (“DFG”), glycerol formal, 2,6-dioxabicyclo[2.2.1]heptane, 6,8-dioxabicyclo[3.2.1]octane, 1,6-anhydro-β-D-glucopyranoze, and the like. Particular bicyclic acetals may comprise, for example, diformylxylose (“DFX”) or diformyl pentaerythritol (DFP). DFX and DFP, in particular, function as eutectic solvents in novolac resin, with blended melting points between 60° C. and 70° C. Accordingly, the adhesive composition may include a eutectic mixture of novolac resin and DFX and/or DFP.

The cyclic acetal may be synthesized by any process or method known in the art. As mentioned above, cyclic acetals are formed by the reaction of an aldehyde or ketone with a diol in the presence of a solvent and an acid catalyst at elevated temperature (50° C. to 300° C., preferably between 75° C. and 175° C.). The solvent may comprise a polar aprotic solvent or polar protic solvent, whereby the polar protic solvent can act as a reactive solvent. Exemplary solvents may include tetrahydrofuran (THF), 2-methyltetrahydrofuran (2-MeTHF), dioxane, ethylene carbonate, propylene carbonate, dimethyl carbonate, diethyl carbonate, methanol, ethanol, glycerin, etc. The acetal reaction can be produced in a batch process or continuous flow process. The reaction may be catalyzed by an acid catalyst, such as, for example, carboxylic acids, organic poly acids, mineral acid, mono-, di-, tri-, and/or tetra-valent Lewis acids. Exemplary acid catalysts include formic acid, glyoxylic acid, citric acid, sulfuric acid, hydrochloric acid, phosphoric acid, p-toluenesulfonic acid, benzoic acid, zinc chloride, aluminum trichloride, iron (II) chloride, iron (III) chloride, magnesium chloride, and the like or mixtures thereof. The reaction may be conducted under atmospheric pressure, reduced pressure, or high pressure. In some aspects, the reaction occurs at a pressure range of 0 to 1500 psi, including, for example, a pressure range of 0.1 psi to 500 psi, or 10 psi to 250 psi.

Alternatively, the cyclic acetal crosslinking agent may be obtained from biomass, such as milled beech or poplar particles, using an appropriate solvent (i.e., dioxane, THF, 2-MeTHF etc.), an acid, and aldehyde. The acid catalyzes the breakdown of the hemicellulose extracted from the biomass and catalyzes formation of cyclic acetals with formaldehyde and two of the hydroxyl groups, which may be purified and used as the cyclic acetal crosslinking agent.

The cyclic acetal crosslinking agent may be present in the adhesive composition in an amount ranging from 1 to 99 wt. %, based on total weight of the composition. For instance, the cyclic acetal component may be present in the adhesive composition in an amount ranging from 5 wt. % to 95 wt. %, based on the total weight of the composition, including amounts ranging from 10 wt. % to 90 wt. %, 15 wt. % to 85 wt. %, 20 wt. % to 80 wt. %, 25 wt. % to 75 wt. %, 30 wt. % to 73 wt. %, 35 wt. % to 70 wt. %, and 40 wt. % to 68 wt. %, including all endpoints and subranges therebetween. In certain aspects, the cyclic acetal crosslinking agent is present in the adhesive composition in at least 55 wt. %, based on the total weight of the composition.

The formaldehyde binder resin and cyclic acetal crosslinking agent are present in the adhesive composition in a weight ratio of about 5:1 to about 0.25:2.5, such as, for example, about 4.5:1 to about 1:10, about 3.5:1 to about 1:7, about 3:1 to about 1:5, about 2.5:1 to about 1:4, about 2:1 to about 1:3, about 1.5:1 to about 1:2, or about 1:1, including all endpoints and ranges that fall therebetween.

The adhesive composition may further include a processing aid. Exemplary processing aid include, for example, water, methanol, ethanol, glycerin, ethylene glycol, propylene glycol, dihydrolevoglucosenone, levoglucosenone, dipropylene glycol dibenzoate, diethylene glycol dibenzoate, carbonate-based solvents, such as propylene carbonate and glycerol carbonate, esterified solvents, such as triethyl citrate, and the like, and combinations thereof. If present, the processing aid may be included in the adhesive composition in an amount from 0.1 wt. % to 40 wt. %, such as, for example, from 1 wt. % to 30 wt. %, from 3 wt. % to 25 wt. %, from 5 wt. % to 22 wt. %, from 8 wt. % to 20 wt., and from 10 wt. % to 18 wt. %, based on the total weight of the adhesive composition, including all endpoints and subranges therebetween.

The adhesive composition may further include an isocyanate component. The isocyanate component is typically a polyisocyanate having two or more functional groups, e.g. two or more isocyanate (NCO) groups. The polyisocyanate may comprise, for example, any one or more of an aromatic, aliphatic, cycloaliphatic, araliphatic isocyanate and an isocyanate that has been blocked (protected isocyanate). In some aspects, the isocyanate component is selected from the group of methylene diphenyl diisocyanate (MDIs), polymeric methylene diphenyl diisocyanates (pMDIs), toluene diisocyanate (TDI), hexamethylene diisocyanate (HDI), isophorone diiscocyanate (IPDI), naphthalene diisocyanates (NDIs), and mixtures thereof. In some aspects, the isocyanate component is polymeric methylene diphenyl diisocyanates (pMDIs). Polymeric diphenylmethane diisocyanates are also referred to in the art as polymeric diphenylmethane diisocyanates or polymethylene polyphenylene polyisocyanates.

In some aspects, the isocyanate component may comprise an isocyanate-terminated prepolymer, which is the reaction product of an isocyanate and a polyol and/or a polyamine. Suitable polyols include, for example, ethylene glycol, diethylene glycol, propylene glycol, dipropylene glycol, butane diol, glycerol, trimethylolpropane, triethanolamine, pentaerythritol, sorbitol, and combinations thereof. If a polyamine is included, suitable polyamine include, for example, ethylene diamine, toluene diamine, diaminodiphenylmethane and polymethylene polyphenylene polyamines, aminoalcohols, and combinations thereof. Examples of suitable aminoalcohols include ethanolamine, diethanolamine, triethanolamine, and combinations thereof. The isocyanate-terminated prepolymer may be formed from a combination of two or more of the aforementioned polyols and/or polyamines.

The adhesive composition may include one or more “additional components,” which may include, but not limited to, polar solvents, non-polar solvents, formaldehyde scavengers, plasticizers, rheology modifiers, fillers, flame retardants, lubricants, softening agents, pigments, biocides, latent acid donors such as acid anhydrides and/or alkyl esters, surfactants, latexes, hydrophobic agents (e.g., waxes), combinations thereof and a combination comprising one or more of these.

Exemplary fillers include, but are not limited to, an organic filler, a mineral filler, and combinations thereof. Examples of suitable organic fillers include cellulosic material, organic polymer fibers, such as carbon fiber, biochar, and combinations thereof. Cellulosic materials may include wood or wood byproducts like wood flour, wood fibers, sawdust, wood shavings; paper or lignin products or byproducts; plant materials such as flax, hemp, wheat straw, rice hulls, soy hulls, kenaf, jute, sisal, seed shells (e.g., peanut or walnut shells), other natural fibers; and combinations thereof. Cellulosic material should be understood herein to include lignocellulosic material. Examples of suitable mineral fillers include any solid inorganic material, preferably inorganic particulates or fibers. Such inorganic materials include calcium carbonate (CaCO₃), graphite, silicas, silicates, aluminas, aluminates, aluminosilicates, talc, mica, clay, feldspars, diatomaceous earth, fumed silica, amorphous silica, fumed aluminum oxide, sand, wollastonite, carbon black, TiO₂, glass fibers, glass beads, glass spheres, mol sieves, ceramic spheres, pigments, and combinations thereof.

Exemplary formaldehyde scavengers include ammonium salts, primary amines, melamine, ethylene urea, urea, resorcinol, tannins, hydroxyacetophenone, and combinations thereof. Exemplary plasticizers include ethylene and propylene glycol oligomers, hydroxyaryl compounds, glycerin esters, gum rosins, sugars, phosphate esters and combinations thereof. Exemplary rheological modifiers include carboxymethyl cellulose, hydroxyethyl cellulose, hydroxymethyl cellulose, attapulgite clays, sepiolite clays, organo-clays, polyvinyl alcohols, starches, xanthan gum, guar gum, alginate, polyglucans, polyurethane-based rheology modifiers, such as hydrophobically modified ethoxylate urethane compounds (HEUR), hydrophobically modified polyethers (HMPE), and combinations thereof. Exemplary flame retardants include silica, melamine phosphate, melamine borate, pentaerythritol, melamine cyanurate, expandable graphite, pentaerythritol polyphosphate ester, alkyl phosphate esters, trimethyl borate, borate esters, zinc borate, guanylurea phosphate, magnesium oxide, ammonium polyphosphate and combinations thereof. Exemplary polar solvents include water, ethanol, methanol, glycerin, dihydrolevoglucosenone, levoglucosenone, dipropylene glycol dibenzoate, diethylene glycol dibenzoate, carbonate-based solvents, such as propylene carbonate and glycerol carbonate, esterified solvents, such as triethyl citrate, and combinations thereof. Exemplary surfactants include Surfynol 104H, Surfynol 420, Dynol 360, Dynol 980, Carbowet 106, Carbowet 109, Silres BS168, FC-402, free fatty acids, polysiloxanes, polyacrylates, fluorosurfactants and combinations thereof. Exemplary latent acid donors include but are not limited to maleic anhydride, acetic anhydride, trimethyl citrate, triethyl citrate, ammonium sulfate, methyl salicylate, and combinations thereof. In general, the additional components, when used, may be present in an amount that does not affect the desired properties of the adhesive composition.

The one or more additional components may optionally be present in the adhesive composition in an amount from 0 to 60 wt. %, such as, for example, from 0.1 wt. % to 50 wt. %, from 0.5 wt. % to 30 wt. %, from 1 wt. % to 25 wt. %, from 3 wt. % to 20 wt. %, from 5 wt. % to 17 wt. %, or from 7 wt. % to 15 wt. %, including all endpoints and subranges therebetween.

The mixture comprising the formaldehyde binder resin, cyclic acetal crosslinking agent, optional processing aid, and optional additives, herein referred to as the adhesive composition, may be compounded at a temperature range of 20° C. to 100° C., ideally between 21° C. to 90° C., preferably between 25° C. and 85° C. After consolidation, the composition may be cooled to 25° C. and has a shelf life of up to 12 months depending on the final composition.

The adhesive composition may be cured (crosslinked) thermally as-is or may include an acid catalyst to promote curing (crosslinking) between the formaldehyde binder resin and cyclic acetal crosslinking agent and/or increase the cure rate of the composition. The acid catalyst used to promote curing includes but is not limited to carboxylic acids, aromatic carboxylic acids, linear acid anhydrides, cyclic acid anhydrides, acyl chlorides, chloroformates, Lewis acids, inorganic acid, thermally generated acids, alkyl esters, aromatic esters, aromatic alkyl esters, UV activated acids, phosphate esters or combinations thereof. Examples include but are not limited formic acid, glyoxylic acid, citric acid, sulfuric acid, hydrochloric acid, p-toluenesulfonic acid, phosphoric acid, zinc chloride, aluminum trichloride, iron (II) chloride, iron (III) chloride, magnesium chloride, methyl salicylate, methyl formate, ethyl formate, trimethyl citrate, triethyl citrate, maleic anhydride, acetic anhydride, methyl chloroformate, acetyl chloride, phthalic acid, benzoic acid, ammonium sulfate, 3-ammoniumphenol sulfate, boric acid, pentaerythritol phosphate ester, resorcinol diacetate and combinations thereof. In certain aspects, the acid catalyst may have an acidic pKa no greater than 6 and, in some instances the acid is a strong acid, defined by having a pKa of less than 2, such as less than 0, −1, −2, −3, or less than −5.

The cure rate of the adhesive composition can be adjusted to a desired speed by catalyst loading. If present, the acid catalyst may be included in the adhesive composition in an amount from 0.01 wt. % to 10 wt. %, such as, for example, from 0.05 wt. % to 8 wt. %, from 0.1 wt. % to 5 wt. %, from 0.2 wt. % to 3 wt. %, and from 0.25 wt. % to 1 wt., based on the total weight of the adhesive composition, including all endpoints and subranges therebetween.

Due to the excess of formaldehyde in phenol-formaldehyde resole resins, a catalyst is not necessary for crosslinking to occur between such phenol-formaldehyde resole resin and the cyclic acetal. However, an acid catalyst may nonetheless optionally be added if faster cure speeds or lower temperature curing is desired.

Additionally, eutectic mixtures, such as a mixture of novolac resin and diformylxylose and/or diformyl pentaerythritol, can be cured in the absence of an acid catalyst, when in the presence of an isocyanate, such as pMDI. Accordingly, the adhesive composition may include a eutectic mixture and pMDI, such as, for example, a novolac resin, diformylxylose and/or diformyl pentaerythritol, and pMDI. Such compositions may optionally further include a base catalyst, such as triethanolamine, sodium hydroxide, ammonium hydroxide, and the like.

Certain aspects of the invention are directed to a liquid adhesive composition that includes a phenolic formaldehyde binder resin component and a mono or bicyclic acetal crosslinking agent, such as diformylxylose (DFX). The mono or bicyclic acetal may be liquid at room temperature or may be heated to form a cyclic acetal melt. DFX, in particular, is solid at room temperature. The phenolic formaldehyde binder resin is in the form of a solid, such as a powder, that may be dissolved within the cyclic acetal melt, optionally in the presence of water, or another processing aid, thus forming a liquid adhesive composition. The liquid adhesive composition has a viscosity at 25° C. between 100 and 10,000 cPs, such as, for example, between 500 and 5,000 cPs, between 800 and 3,000 cPs, or between 1,000 and 2,500 cPs.

### Compositional Properties

The adhesive composition has a number of improvements over conventional adhesive compositions. For instance, the adhesive composition includes low-to-no VOCs or formaldehyde emissions, has improved shelf-life stability, desirable cure conditions, and/or increased cure rates. The VOC emissions may occur from two sources. The first potential source is during the production process, specifically while a composite is being thermally cured. The second source of VOC emissions is from the finished composite or article while in normal use (passive emissions). In certain aspects, the adhesive composition and/or any article or product produced therewith demonstrates reduced VOC emissions compared to conventional phenol-formaldehyde-based adhesive compositions and/or articles or products produced therewith, when measured in accordance with ASTM D7770-12 and/or CDPH Standard Method V1.2.

For instance, the adhesive composition is curable at a temperature of 100° C. and above, and has a preferable cure temperature of between 115° C. and 150° C. Although the adhesive composition may be cured more quickly at higher temperatures, curing at about 125° C. for about 10 minutes results in a desirable coloring and does not turn black or other discoloring issues.

The adhesive composition is also shelf-stable for a longer period of time, compared to conventional phenol-formaldehyde-based adhesives. Particular improvements are seen in the stability of the liquid adhesive compositions. Shelf stability may be measured by a composition's shelf-life, which may itself be defined as the time it takes for a composition to gain 50% of its initial viscosity. For instance, resoles generally have a shelf-life of about 20-30 days at ambient temperature (25° C.) and this shelf-life is reduced to about 3-12 days when stored at an increased temperature of about 32° C. to about 38° C. The liquid adhesive composition disclosed herein demonstrates an improved shelf-life of at least 3 months, or at least 6 months at ambient temperature and at least two weeks or greater at increased temperatures.

### Method of Manufacturing

The adhesive composition may be prepared by blending or otherwise mixing the formaldehyde binder resin with a cyclic acetal crosslinking agent. The formaldehyde binder resin and cyclic acetal crosslinking agent may each be in the form of a solid, such as a powder or other solid form that is ground and pre-processed into a blendable form, or in the form of a liquid. In aspects whereby each of the binder resin and cyclic acetal are in a solid, powder form, the powders may be mixed and blended to form a blended powder adhesive precursor. The blended powder adhesive precursor may be used as-is in the powder form (with or without a solid acid catalyst), or it may be heated to a temperature sufficient to melt the blended powder, optionally in the presence of water or catalyst forming a single-phase, adhesive melt composition. One or more additives may be included in the adhesive melt composition, which may then be dried, cooled, or otherwise treated to obtain an adhesive composition.

In aspects whereby the adhesive composition is a liquid adhesive composition, the cyclic acetal crosslinking agent is in a liquid form and the formaldehyde binder resin is dissolved therein to form a liquid adhesive composition. Thus, the liquid cyclic acetal crosslinking agent has a dual function of acting both as a solvent and a crosslinking agent. In some aspects, the cyclic acetal crosslinking agent is at liquid at room temperature and does not require heating or other treatment prior to introduction of the formaldehyde binder resin. For instance, 1,3-dioxolane is liquid at room temperature. In other aspects, such as in the case of DFX that is a solid at room temperature, the cyclic acetal crosslinking agent may be heated to a temperature above its melting point to form a liquid. The formaldehyde binder resin is then dissolved in the liquid crosslinking agent, optionally, in the presence of a processing aid, such as water, and a catalyst to form the liquid adhesive composition. The amount of processing aid and/or optional additional components may be adjusted to achieve a target viscosity. In certain aspects, the liquid adhesive composition has a viscosity at 25° C. between 100 and 10,000 cPs, such as, for example, a viscosity at 25° C. between 500 cPs and 7,000 cPs, between 700 cPs and 5,000 cPs, between 1,000 cPs and 3,000 cPs, and between 1,500 cPs and 2,500 cPs, including all endpoints and subranges therebetween. The viscosity is measured by a rheometer with 40 mm parallel plates, a 0.6 mm gap, and 0.33 rad/s velocity.

### Adhesive System

According to certain aspects, the adhesive composition may form a component of a two-part adhesive system that includes the adhesive composition along with the acid catalyst, as disclosed above. The adhesive composition and acid catalyst may be packaged separately or may be packed in a single package with the catalyst separated from the adhesive, so as to avoid premature cure. The use of the acid catalyst reduces the curing time of the adhesive composition, compared to the adhesive composition without the acid catalyst under the same curing conditions. Thus, the two-part adhesive system provides an adhesive that is capable of curing with a reduced cure time.

### Composite Article

The adhesive composition is suitable for manufacturing a composite article and in particular, composite articles comprising substrates formed of lignocellulose material (i.e., wood particles, wood fibers, straw, hemp, cotton stalk, wheat, bamboo, jute, flax, hard woods, soft woods, grasses, etc.), paper, fiberglass, cellulose, metal, sand, polymer materials, synthetic materials, and the like. Exemplary lignocellulose-based composites include oriented strand board (OSB), particleboard, flake board, medium or high-density fiberboard, waferboard, plywood, laminated veneer layer (LVL), laminated glulam beam, mass timber, cross-laminated timber (CLT), medium density overlay (MDO), high density overlay (HDO), an overlaid weather barrier, high pressure laminates (HPL), or thermally fused laminates (TFL), and the like.

In any of the various composite article manufacturing processes set forth below, the adhesive composition disclosed herein may be applied or otherwise associated with one or more substrates as a one-part composition, meaning that the adhesive composition includes the catalyst within the composition. Alternatively, the adhesive composition comprises a two-part system, whereby the formaldehyde resin/cyclic acetal/processing aid mixture and the catalyst are combined shortly before applied or are applied separately. In such systems with separate applications, the mixture and the catalyst may be added as separate coatings, beads, extrudate, and the like, with pressure and/or heat applied thereto effective to promote mixing of the components.

The adhesive composition (inclusive of the one-part composition or two-part system) may be applied to the substrate in an amount in the range of 0.5 wt. % to 20 wt. %, based on the total weight of the coated substrate, including, for example, 1 wt. % to 15 wt. %, 1.5 wt. % to 10 wt. %, 2 wt. to 8 wt. %, and 2.5 wt. % to 7 wt. %, including all endpoints and subranges therebetween.

According to a first aspect, a composite article may be produced by applying an adhesive composition to a substrate, such as by coating, blending, or spraying the substrate with the adhesive composition, forming a coated substrate (also referred to as a “first” substrate). As mentioned above, the substrate may comprise wood or wood particles, fiberglass, paper, glass particles or beads, lignocellulose, cellulose, metal, sand, polymer, synthetic materials, and the like. The adhesive composition may be applied to or blended with the substrate materials using any known method, such as by blender, roll coater, curtain coater, dip coater, spray booth, extruder, and the like. Alternatively, the adhesive composition may comprise a two-part system (separately applied adhesive composition and acid catalyst) that is extruded onto the substrate. The resulting composite may have 2 or more layers of adhesive composition.

In some instances, the coated substrate is then pressed between one or more plates at an elevated temperature sufficient to initiate curing of the adhesive composition and for a sufficient amount of time to complete curing, forming the composite article. Conventional processes for compressing a coated substrate are generally carried out by hot pressing along with heat transfer from hot surfaces. The press pressure during which hot pressing occurs may be between about 100 psi and about 220 psi, including, for example, between about 130 psi and about 210 psi, and between about 140 psi and about 190 psi. The temperature at which the coated substrate is pressed may be at least 60° C. for at least 2 minutes, such as, for example a temperature of 60° C. to 250° C., including for example, 100° C. to 125° C., for about 2-15 minutes. Optionally, the coated substrate can be pre-pressed (e.g., cold pressed) prior to hot pressing. For example, the article may be pre-pressed for a period of time, such as 1 minute to 60 minutes at ambient temperature prior to hot pressing, including, for example, a pre-pressing period of 1 minute to 20 minutes, or from 1 minute to 10 minutes.

In other processes, such as a lam-beam manufacture, the coated substrate is pressed via a radio frequency (RF) press, where the coated substrate is pressed at a pressure of about 100 psi to about 210 psi, including, for example pressures between about 115 psi to about 200 psi, and about 125 psi to about 180 psi. While being pressed, the radio frequency heats up the adhesive composition, promoting cure. The adhesive may reach temperatures of about 35° C. to about 150° C., including, for example, temperatures of about 60° C. to about 140° C., and about 100° C. to about 130° C. The composite may be pressed for a period of time sufficient to cure and adhere the composite layers, such as for a period of about 2 to about 10 minutes. In such applications, the wood substrate may comprise, for example, Doug Fir (DF), Southern Yellow pine (SYP), bamboo, oak, maple, larch, spruce, and the like.

Alternatively, in some systems, the coated substrate may be pressed and cured at ambient temperatures.

The composite article may comprise one or more additional substrates, such that the first substrate with the adhesive composition coated thereon, is pressed using a second substrate. The second substrate may optionally be pre-coated with the adhesive composition, prior to the pressing step. The first substrate and one or more additional substrates may comprise the same material, or may comprise different materials. In any aspect, at least one of the first substrate and one or more additional substrates comprise a cellulose material.

The composite article formed in accordance with the above method may comprise, for example, plywood, a laminated veneer layer (LVL) product, laminated glulam beam, mass timber, oriented strand board (OSB), cross-laminated timber (CLT), particle board, medium density fiberboard (MDF), or the like. When specifically manufacturing particle board, medium density fiberboard (MDF), or oriented strandboard (OSB), the coated substrate is formed by blending the adhesive composition with a lignocellulosic material. The lignocellulosic material may comprise, for example, wood chips, wood fiber, wood powder, or wood flour.

According to a second aspect, a composite article may be produced by saturating or impregnating a substrate with the adhesive composition. Such an application method may be used with any substrate discussed above, but finds particular application in the production of fiberglass and paper substrates. The substrate may be saturated or impregnated with the adhesive composition according to any known method, such as, for example, by placing the substrate in a resin bath and submerging the substrate therein, by applying the adhesive composition in such a way as to allow the adhesive to bleed through the substrate thickness, or a combination thereof. For example, the adhesive composition may be placed in a saturating pan and heated to about 20-25° C. A substrate is then passed through the pan and excess composition is squeezed or otherwise removed from the substrate using any known means, such as a nip roll.

The saturated or impregnated substrate is then allowed to cure, such as by placing the saturated or impregnated substrate in an oven at an appropriate temperature (i.e., 100° C.-150° C.) to cure the adhesive composition, forming a composite article. The oven further reduces the volatile content of the saturated substrate to below 5%, and preferably below 3%. The composite article may comprise, for example, medium density overlay (MDO), high density overlay (HDO), an overlaid weather barrier, high pressure laminates (HPL), or thermally fused laminates (TFL).

Unlike conventional resin systems for saturating or impregnating paper and fiberglass, the adhesive system disclosed herein does not require high amounts of VOC solvents. Additionally, conventional resin saturation systems tend to have a short shelf-life (as short as a week or less) before polymer advancement, separation, or precipitation occurs. Since the cyclic acetal provides a solvent functionality, the adhesive composition provides a shelf-stable system that can function as a low VOC saturating composition for paper and fiberglass applications, for example.

According to a third aspect, a composite article may be produced by pressure infusing lumber or wood veneer with the adhesive composition. The formaldehyde binder/cyclic acetal/processing aid mixture is first mixed with the acid catalyst at about 25-35° C. to provide a single phase, homogenous composition. The composition may then be loaded into an infusion chamber containing the lumber. Exemplary species of wood lumber include Douglas Fir, Southern Yellow Pine, spruce, larch, maple, oak, bamboo, or a mixture of. The infusion chamber is then sealed and pressure is applied in the range of 50 psi to 150 psi for a period of time, such as 1-2 hours. The pressure may then be reduced down to atmospheric pressure, and the remaining composition is removed and can be recycled. Once the composition is removed from the infusion chamber, the lumber is removed and set to a pre-cure state at 35-55° C. for a period of time, such as between 5 and 24 hours. The pre-cure state may be a partially cured or “B-staged” state, whereby the adhesive composition is heated to a tackifying temperature without cross-linking, such that the adhesive composition will adhere the lumber or wood veneer, but remains uncured. B-staging a product allows the product to be initially produced and adhered in one location, with final curing taking place at a second location at a later date. B-staged products have increased flexibility and are often easier to transport and install before being fully cured.

Once the pre-cured lumber or wood veneer is ready to fully cure, it may be thermally cured at a temperature sufficient to cure the infused adhesive composition, thereby forming the composite article. Thermal cure can be accomplished in either an oven or Radio Frequency (RF) cured. Such composite articles may include pressure treated lumber or pressure treated veneer.

The composite articles formed in accordance with the subject invention meet the standards set forth in ASTM D2559 and CSA 0112.9-10.

In any aspect of the invention, the cyclic acetal may be blended with a formaldehyde resin to produce an adhesive composition for wood composite boards, including but not limited to particleboard, MDF, or OSB. The acetal/resin blend may be used in a weight ratio range of 0.10:1.0 to 1.0:0.10. An acid or latent acid catalyst may be utilized in the range of 0-10% by weight. Optionally, water or other processing aid may be added to the acetal/resin blend in a range of 0-70 wt. %. Optionally, urea, solvents, or other co-reactants and fillers may be added in the range of 0-70 wt. %. The ingredients may be combined in a stable 1-part system, prior to blending with wood fiber or chips, or the ingredients may be blended upon addition to the wood fiber or chips. In the wood composite board itself, the adhesive composition may be included in the board in an amount from 0.5 to 20 wt. %, and may be pressed to cure at about 60-250° C. for about 0.1 to 20 minutes. According to other aspects, the adhesive composition may be included in the board in an amount from 1 to 10 wt. %, and be pressed to cure at about 90-150° C. for about 5-10 minutes.

In another aspect the cyclic acetal and formaldehyde resin may be applied to a substrate in the form of a solid powder, containing the cyclic acetal, formaldehyde resin, and optionally a catalyst, fillers, and other additives. The powders may be blended upon application to the substrate or preblended in advance.

In yet another aspect, the cyclic acetal and formaldehyde resin may be pre-blended as a powder, prior to melting and optionally blending with processing aids, catalysts, co-reactants, and/or fillers. Examples of processing aids include but are not limited to glycerol, polypropylene glycol, polyethylene glycol, and water. The acetal/resin blend may be melted between 60-200° C. Preferably, the acetal/resin blend is melted between 80-120° C. Once melted, the acetal/resin blend may be extruded, roll coated, curtain coated or applied as an adhesive or coating by any means known to those skilled in the art.

### EXAMPLES

The following examples are included for the purposes of illustration, and do not limit the scope of the general inventive concepts described herein.

### Example 1—Preparation of a Liquid Adhesive Composition

A solid powder of diformylxylose (DFX) was prepared according to methods conventional in the art. Exemplary liquid adhesive compositions were prepared by heating solid powdered DFX (60 g) to 65° C. in a hot water bath to form a DFX melt. The DFX melt was mixed with powdered novolac resin (Plenco 14845) (30 g) and deionized water (5 g). The mixture was then heated to 90° C. and mixed to completely dissolve the novolac resin powder, forming a translucent, orange, single-phase solution. The solution was cooled to 24° C. and remained a single-phase solution with no precipitation. This solution forms a eutectic mixture.

### Example 2—Preparation of Liquid Adhesive Compositions

Four additional liquid adhesive compositions were prepared in accordance with Example 1, but including varying ratios of DFX, novolac resin, optional H₂SO₄, and optional water. Each composition in this Example 2 form a eutectic mixture of DFX and novolac resin. These are shown as Examples 2-1 to 2-4 in Table 1 below. Particularly, Examples 2-1 and 2-4 include the addition of 5 grams of 1 N H₂SO₄ and Examples 2-1, 2-3, and 2-4 include varying amounts of water. Table 1 further illustrates the resulting viscosities at 25° C. of each composition. The viscosity was measured by a rheometer with 40 mm parallel plates, a 0.6 mm gap, and a velocity of 0.33 rad/s. As illustrated in Table 1, Example 2-2 demonstrated a high viscosity, which indicates the importance of a processing aid (water) in applications requiring a lower viscosity.

TABLE 1

| | Novolac resin | DFX | Water | H₂SO₄ | Viscosity |
|---|---|---|---|---|---|
| Example | (wt. %) | (wt. %) | (wt. %) | (wt. %) | (cP) |
| 2-1 | 30 | 60 | 9.75 | 0.25 | 2150 |
| 2-2 | 33.3 | 66.7 | 0 | 0 | 183000 |
| 2-3 | 30 | 60 | 10 | 0 | 2160 |
| 2-4 | 28.3 | 56.7 | 14.75 | 0.25 | 2250 |

### Example 3—Solvating Novolac Resin

### Example 3-1: Solvating Novolac in Glycerol Formal

In a glass jar, 25 g of novolac (Plenco 14845) was mixed with 50 g of glycerol formal and was allowed to solubilize overnight. The novolac started to dissolve gradually into the glycerol formal at room temperature without mechanical stirring. To aid mixing, the mixture was placed in an oven at 110° C. for approximately 4 hours, or until a homogeneous mixture was achieved. The jar was mechanically shaken every 20 minutes to promote blending. Once complete, the mixture was allowed to cool to room temperature. The mixture remained a single-phase solution with no precipitation after cooling to room temperature and demonstrated stability at 4° C., 25° C., and 35° C. The viscosity was measured to be 900 cP using a rheometer with 25 mm parallel plates, a 0.6 mm gap, and an angular velocity of 0.33 rad/s.

### Example 3-2: Solvating Novolac in 1,3-Dioxolane

In a glass jar, 25 g of novolac (Plenco 14845) was combined with 25 g of 1,3-dioxolane and left to mix at room temperature. The jar was shaken vigorously every 20-30 minutes to facilitate mixing, resulting in a homogeneous mixture after 6 hours. The mixture remained a single-phase solution with no precipitation at room temperature and demonstrated stability at 4° C., 25° C., and 35° C. The viscosity was measured to be 4270 cP using a rheometer with 25 mm parallel plates, a 0.6 mm gap, and an angular velocity of 0.33 rad/s.

### Example 3-3: Solvating Novolac in Diformyl Pentaerythritol

In a glass jar, 25 g of novolac (Plenco 14845) was combined with 50 g of diformyl pentaerythritol (DFP), and the solids were mixed to ensure even dispersion. The mixture was then heated in an oven at 110° C. for approximately 4 hours, during which DFP melted and dissolved novolac. By the end of the 4 hours, a homogeneous, viscous liquid was formed. The jar was mechanically shaken every 20-30 minutes to promote thorough mixing. Once the mixture became uniform, the mixture was allowed to cool to room temperature. The mixture formed a eutectic mixture and remained a single-phase solution with no precipitation after cooling to room temperature.

### Example 3-4: Solvating Novolac in Diformyl Glucose

Diformyl glucose (DFG), a viscous liquid acetal at ambient conditions, and Plenco 15847 were blended at a ratio of 1:1 wt. % and placed in a 115° C. oven to induce melting of the Plenco 15847 over the course of roughly 2 hours. The blend was quickly removed and vigorously mixed together, yielding a viscous liquid mixture of solvated novolac and DFG. Next, propylene carbonate and water were introduced, followed by pTSA (70% aq.), and the mixture was homogenized once more before rheological testing.

### Example 4—Curing the Liquid Adhesive Composition

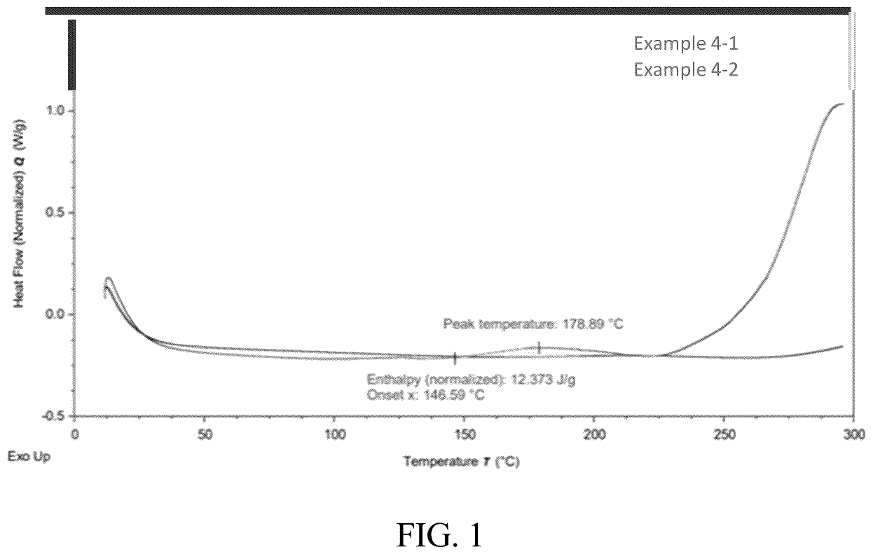

A liquid adhesive composition (Example 4-1) was prepared as described above in Example 1. The composition included water, DFX, and novolac resin (Plenco 14845) in a weight ratio of 1:8:4 and was tested by differential scanning calorimetry (“DSC”). DSC was performed on a TA instruments DSC2500 using high-pressure capsules with a 10° C./min ramp from 10° C. to 300° C. This solution was also tested with the addition of 5 wt. % 1 N H₂SO₄ (Example 4-2). The DSC results of Examples 4-1 and 4-2 are illustrated in FIG. 1. As illustrated in FIG. 1, Example 4-1, including the acid, demonstrated a moderate exotherm with an onset point at 147° C. and then a large exotherm at 225° C. Example 4-2, which excludes the acid, was unreactive until an exotherm began at 275° C.

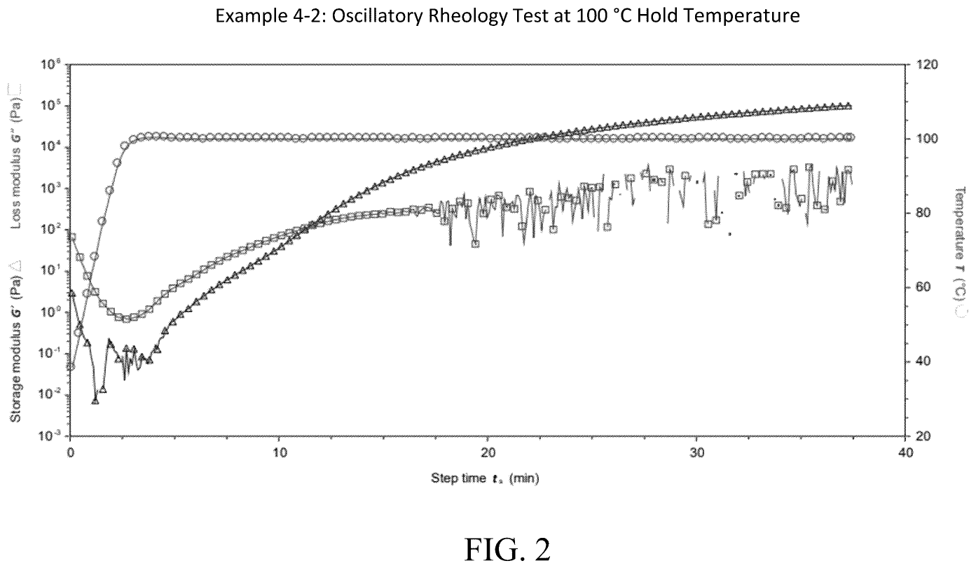

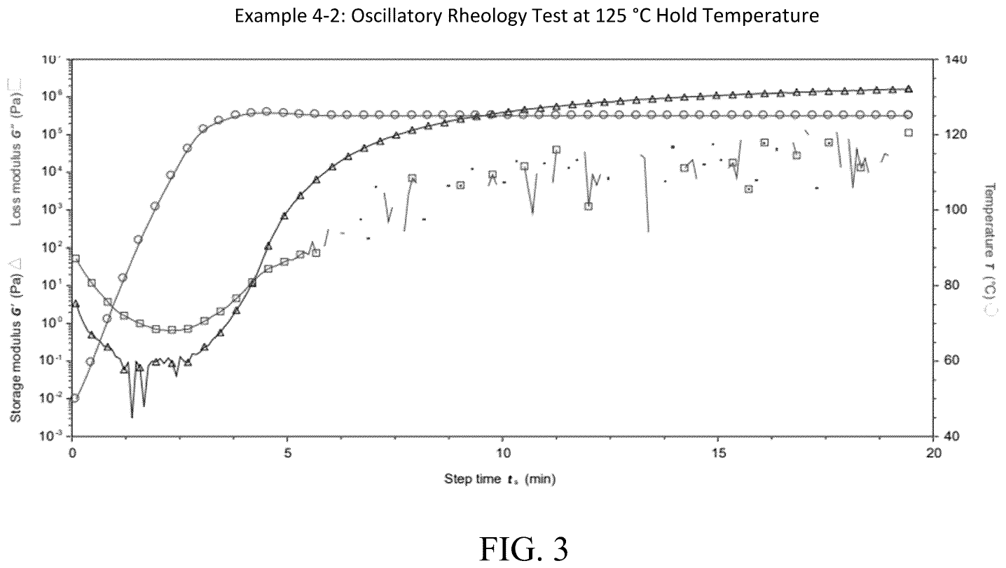

Oscillatory rheology tests were performed on Example 4-1 to observe the curing of the solution at elevated temperatures of 100° C. and 125° C., and the results are illustrated in FIGS. 2 and 3. As illustrated in FIG. 2, at 100° C., Example 4-1 exhibits a G′/G″ crossover about 10 minutes after reaching the 100° C. hold temperature. From here, the storage modulus gradually increased for about another 25 minutes. Example 4-1 was observed to be solid and cured on the outer edges of the rheometer plate, but a very viscous liquid within the cell. As shown in FIG. 3, at 125° C., Example 4-1 exhibits a G′/G″ crossover within about 1 minute of reaching the 125° C. hold temperature. The storage modulus quickly increased and started to level off after about 7 minutes, but still gradually increased after about 15 minutes. This sample was hard and glassy on the outside of the rheometer plate, as well as within the cell.

### Example 5—Glued Plywood Tests with Liquid Adhesive Composition

Plywood samples were manufactured from ⅛^{th} inch Douglas fir veneer cut to 3″×3″ squares. A liquid adhesive composition according to Example 2-4 (as shown in Table 1) was prepared as described in Example 2. Three 3-ply panels were prepared by spreading the liquid adhesive composition on veneers with a metal spatula and pressing in an electric press according to the conditions outlined below in Table 2. The cured test specimens were then evaluated for their performance in a PS-1-22 AVP (autoclave vacuum pressure) test which evaluates bond strength and water resistance. As shown by the results reported in Table 2, plywood bond with the Example 2-4 adhesive showed excellent bonding results above 90% wood failure (“WF”) for 170° C. and 150° C. cures and nearly passed the target of 85% WF for 125° C. cure. Additionally, the cured glue lines in Panel 3 were a desirable brown color while panels 1 and 2 had black glue lines.

TABLE 2

| | Panel 1 | Panel 2 | Panel 3 |
|---|---|---|---|
| Press temperature (° C.) | 170 | 150 | 125 |
| Press time (min) | 10 | 10 | 15 |
| Spread rate (lb/1000 sq ft) | 31.7 | 27.3 | 22.9 |
| Spread rate (g/9 sq in) | 0.9 | 0.775 | 0.65 |
| AVG AVP breaking load | 213 | 177 | 167 |
| (psi) | | | |
| AVG AVP % WF | 93 | 92 | 82 |

### Example 6—Preparation of Solid Hotmelt Adhesive Compositions

A solid DFX powder (5 g) was blended with powdered novolac resin (Plenco 14845) (2.5 g). The resulting powder blend was melted at 100° C. to produce a thermoplastic adhesive composition, described below in Table 3 (Example 6-1). A second blend was prepared with 4 g of solid DFX powder and 4 g of powdered novolac resin (Plenco 14845). The resulting powder was melted at 100° C. to produce a thermoplastic adhesive composition, described in Table 3 (Example 6-2).

TABLE 3

| | | | Viscosity | Viscosity | Viscosity |
|---|---|---|---|---|---|
| | Novolac resin | DFX | (cPs) at | (cPs) at | (cPs) at |
| Example | (wt. %) | (wt. %) | 50° C. | 70° C. | 80° C. |
| 6-1 | 33.3 | 66.7 | 5,960 | 810 | 360 |
| 6-2 | 50 | 50 | 174,600 | 10,100 | 4140 |

Table 3 illustrates the resulting viscosities at 50° C., 70° C., and 80° C. of each composition. The viscosity was measured by a rheometer with 25 mm parallel plates, a 0.6 mm gap, and a velocity of 0.33 rad/s.

### Example 7—Paper Saturation

### Example 7.1—DFX

A eutectic mixture of diformyl xylose and novolac (Plenco 14845) was formed in a 2:1 ratio in an oven at 100-110° C. until a homogenous, viscous liquid formed. A glue mixture was then prepared containing 73 wt. % of the DFX-novolac liquid, 18 wt. % water and 9 wt. % of 70% pTSA aq. solution, which was thoroughly stirred with a wooden popsicle stick. The glue mixture had an average viscosity of 355.9 cP. Two paper pieces were prepared (Saturated Paper I and Saturated Paper II), each measuring 3.3″×3.3″. Each piece was coated with the glue mixture, ensuring both surfaces were evenly covered. Excess glue was scraped off, and the papers were clipped to a metal rod using paper clips. The clipped papers were placed in an oven set at 177° C. for 1 minute to cure. The weights of the saturated papers were recorded.

Saturated Paper I was then pressed onto the surface of a 3-ply Douglas Fir panel (where the plies were glued using a PF glue) and subjected to 150° C. at 190 PSI pressure for 5 minutes, creating a paper overlay on the plywood.

To determine the % resin content and % VOC, a 2.5″×2.5″ unsaturated paper sample was dried in an oven at 160° C. for 10 minutes to eliminate moisture. The weights of the paper before and after oven drying were recorded. The process was repeated with a second sample, and an average weight was calculated. Saturated Paper II was oven-dried at 160° C. for 10 min and the weight was recorded. All the recorded weights were calculated for a 2.5″×2.5″ sized paper before putting into the formula below.

$$\begin{matrix}\% RC ( resin content ) = {100}^{*} ( ( grams of oven - dried saturated paper - ( grams of oven - dried unsaturated control paper ) ) / ( grams of oven - dried unsaturated control paper ) ) \\ \% VC ( volatile content ) = {100}^{*} ( ( grams of saturated paper - grams of oven - dried saturated paper ) / ( grams of saturated paper ) )\end{matrix}$$

The % resin content (RC %) was calculated to be 123.49% and the % VOC was calculated to be 12.2%. Thus, the sample demonstrates that the composition was capable of saturating paper with a low VOC content.

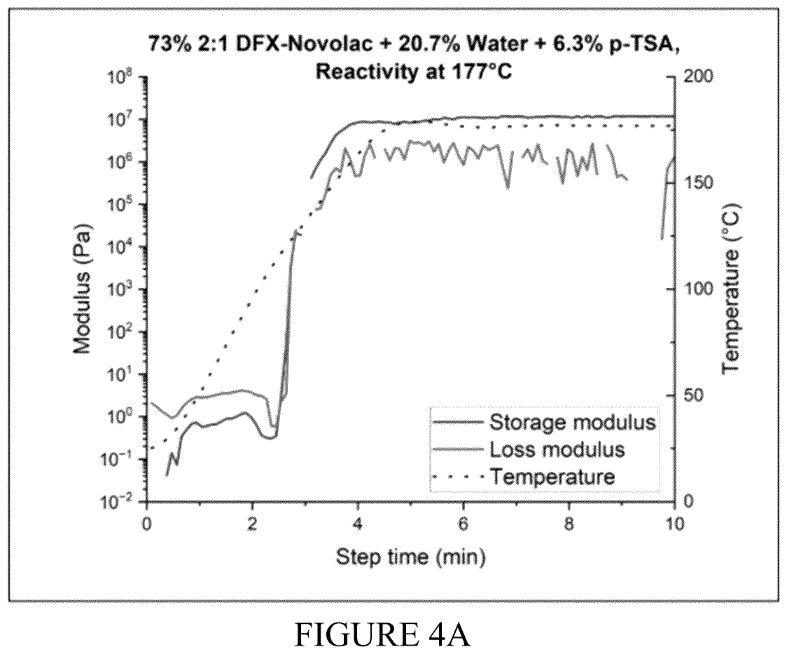

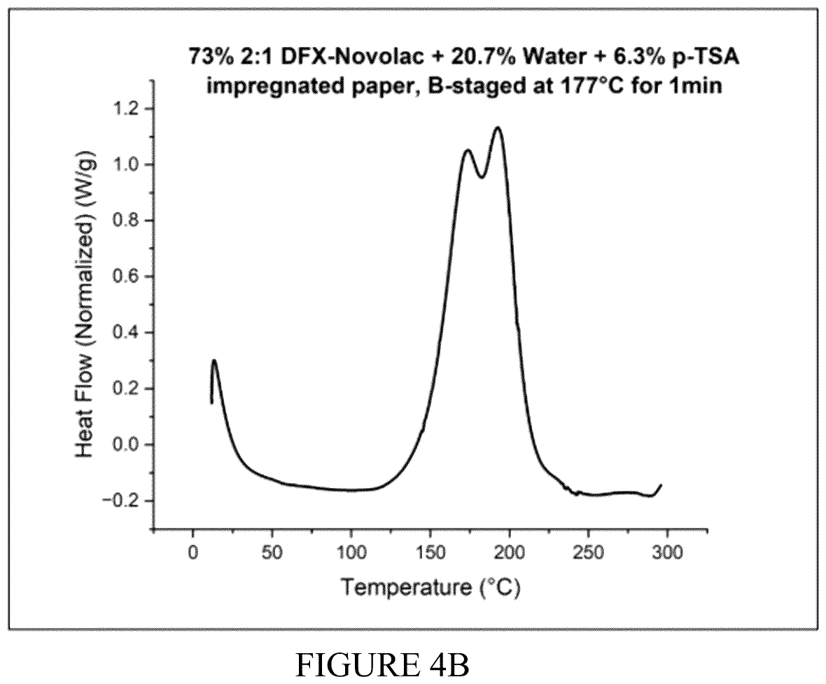

Oscillatory rheology tests were performed before saturating the paper samples at 177° C., and the results are illustrated in FIG. 4A. Oscillatory measurement was accomplished on a TA DHR-1 (Discovery Hybrid Rheometer) rheometer equipped with ETC (Environmental Test Chamber) with a water-cooling attachment, using 25 mm disposable stainless steel parallel plate geometry. The Oscillatory measurement frequency was set to 1 Hz and 0.05% strain amplitude. Upon mixing the 2-part system, samples were immediately loaded onto 25 mm stainless steel parallel plates and heated to 177° C. The samples were held in isothermal at 177° C. unless otherwise specified. Sampling rate was set to maximize the number of points.

As illustrated, the storage modulus quickly increased and started to level off after about 4 minutes, but still gradually increased after about 10 minutes. Gelation occurred at around 2.54 minutes with a storage modulus (G′) of 2.83 Pa at the crossover with loss modulus.

DSC was performed on the saturated paper samples (B-staged at 177° C.) in a high-pressure capsule as shown in FIG. 4B.

### Example 7.2—Glycerol Formal

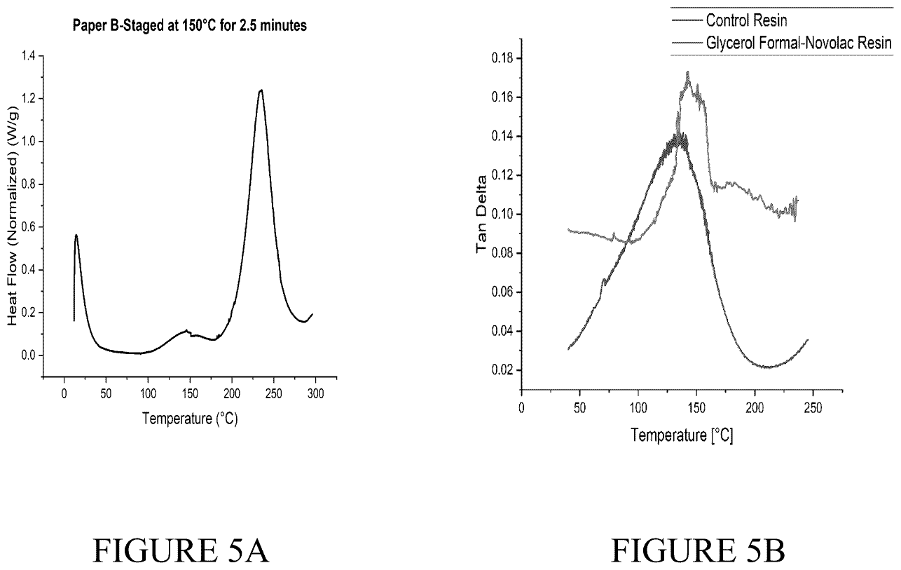

30 g of glycerol formal was added to 15 g of novolac (Plenco 15847) in a glass jar and heated in an oven at 130° C. until a homogenous mix was formed. 70% aq. p-TSA solution was then added and mixed for 1 min to make a formulation including 95.71 wt. % 2:1 glycerol formal: novolac, 1.29 wt. % water and 3 wt. % p-TSA. 4×4″ Kraft papers were soaked in the resin and excess was removed with wooden spatulas. The papers were B-staged at 150° C. for 2.5 min. % RC and % VC of the paper were 61.9% and 15.18% respectively. The glue mix saturated the paper uniformly as it could be seen under the microscope. Measurements were done on the B-Staged paper using DSC and DMA and the results are illustrated in FIGS. 5A and 5B.

### Example 7.3—Glycerol Formal

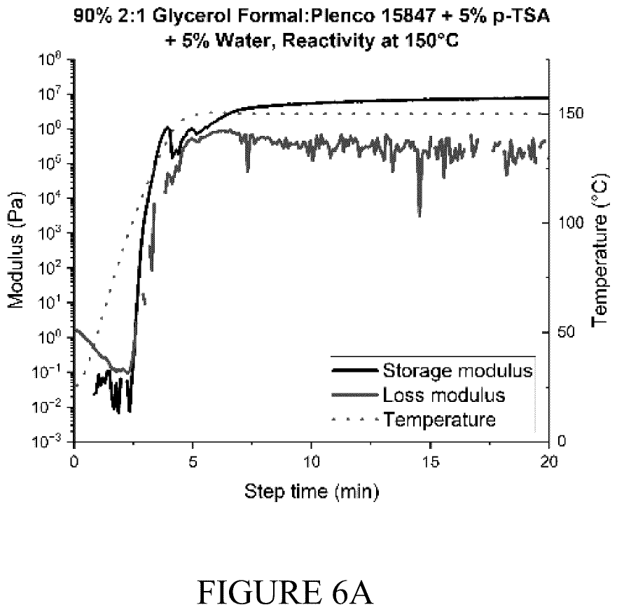

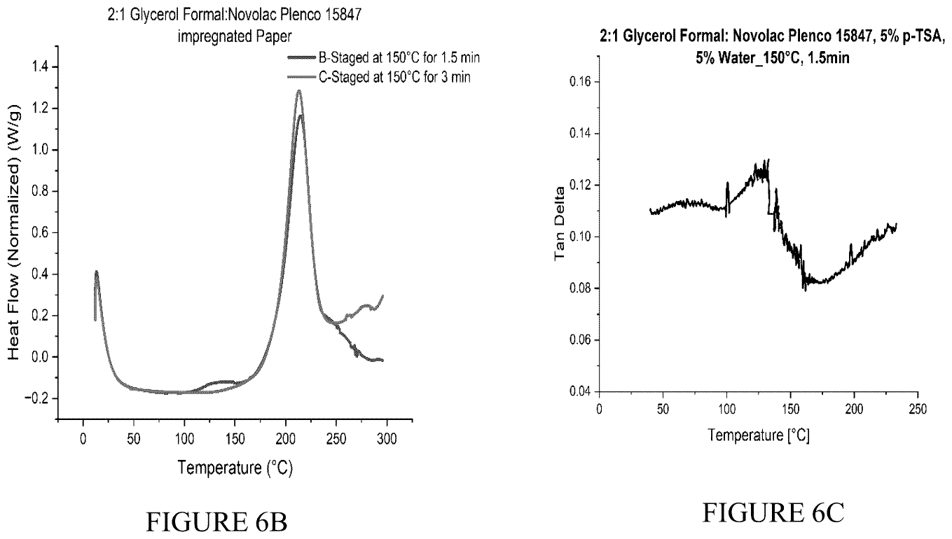

20 g of glycerol formal was added to 10 g of novolac (Plenco 15847) in a glass jar and heated in an oven at 130° C. for 90 min, or until a homogenous mixture was formed, and then the mixture was removed and allowed to cool. A portion of the mixture was added to a vial and 50% aq. p-TSA acid catalyst was added to make a formulation 90% 2:1 glycerol formal: novolac+5% p-TSA+5% Water. The formulation was mixed with a spatula for one minute on addition of the acid catalyst, and viscosity and reactivity measurements were performed on a rheometer before saturating the papers. See FIG. 6A. The viscosity of the formulation was 249.7 cP and the following plot shows the reactivity at 150° C. temperature hold. The viscosity was measured in accordance with disposable parallel plate geometry (25 mm diameter), in an ETC chamber: flow peak hold, 25° C., 2 min, and a velocity of 0.33 rad/sec.

3.5″×3.5″ kraft papers of known moisture content were cut, and the resin was applied to the papers using a roll coater and heated in a 150° C. oven, for 3 min or 1.5 min. FIGS. 6B and 6C illustrate the DSC and DMA plots of the saturated paper, cured for 1.5 min and 3 min. The papers have 72.47% resin content. The paper cured for 1.5 min has 17.49% volatile content whereas the paper cured for 3 min has 9.09% volatile content. FIG. 6B: The DSC data of FIG. 6B displays B-stage curing, a type of pre-cure, and C-stage curing a completely cured saturated paper. B-staged paper could be pressed directly onto the panel surface without the need for additional glue. C-staged paper is completely cured and will require an additional adhesive layer. The small peak between 100° C. and 150° C. in the B-Staged plot of FIG. 6B shows the reactivity (isothermal, strain %=0.05, frequency=1.0 Hz) of that paper, which is absent from the C-Staged plot.

FIG. 6C: DMA data shows Tan (delta) as a function of temperature. At about 100C, the tan delta begins to increase and reaches a maximum at 125° C. After reaching the peak maximum, Tan (delta) begins to decrease reaching a low at about 175° C.

### Example 7.4—Diformyl Pentaerythritol

In a glass jar, 18 g of diformyl pentaerythritol (solid) and 12 g of novolac (Plenco 14845) were added and the eutectic mixture was heated in an oven at 100° C. for 35 min or until it formed a homogenous viscous liquid. The mixture was cooled, and 3 g of water and 3 g of ethanol were added to make Part A. A portion of this Part A was added to a vial and 50% aq. p-TSA solution was also added, resulting in a formulation including 75% 1.5:1 DFP: novolac, 12.5% water, 7.5% ethanol, and 5% p-TSA. The formulation was mixed for 1 min after addition of acid catalyst and loaded on rheometer to measure viscosity at 25° C. and reactivity at 150° C. The average viscosity of the formulation is 380.56 cP. The viscosity was measured in accordance with disposable parallel plate geometry (25 mm diameter), in an ETC chamber: flow peak hold, 25° C., 2 min, and a velocity of 0.33 rad/sec.

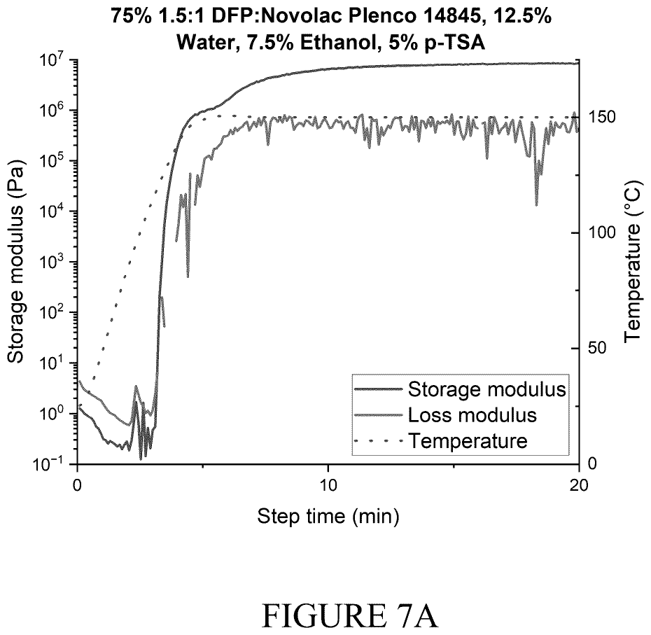

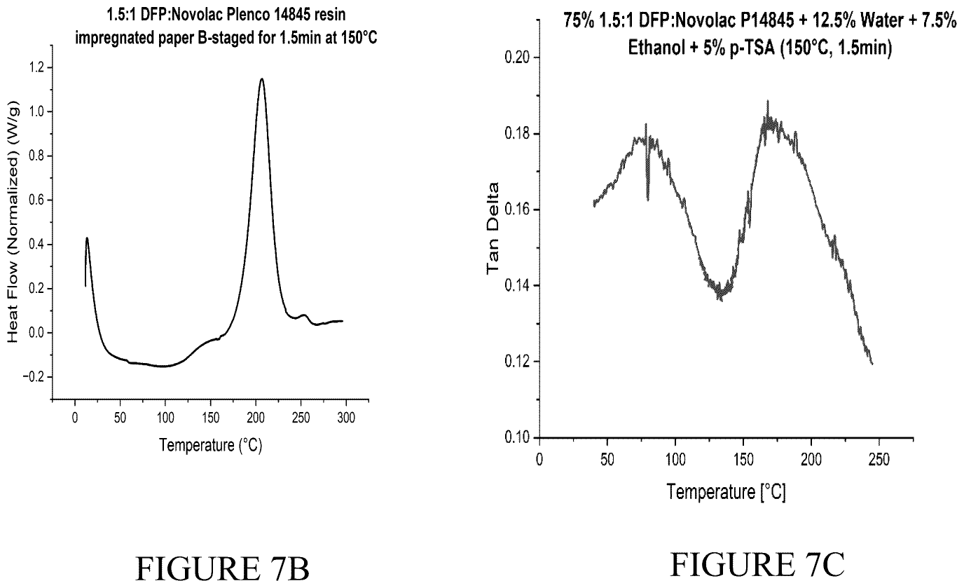

The glue mix was applied to 3″×3″ kraft papers using a roll coater and excess was removed from the surface. The resin impregnated paper was B-staged in oven at 150° C. for 1.5 min. The microscopic image shows that the resin saturated the paper uniformly. % RC and % VC of the B-staged paper was 115.96% and 6.03% respectively. The saturated paper was analyzed on DSC and DMA. See FIGS. 7B and 7C. And the reactivity and modulus growth of the glue mix was measured on rheometer (FIG. 7A). Another saturated paper was overlayed on a 3″×3″ 3-ply poplar panel using a mini press at 150° C. for 5 min and 185 PSI pressure.

### Example 8—Liquid Novolac resin and pMDI Hybrid System (with TEA catalyst)—Eutectic Mixtures

42.37 g of DFX, 35.29 g of novolac (Plenco 15847) (1.2:1 DFX to Novolac), and 10.86 g of propylene carbonate were added to a glass jar and heated in an oven at 130° C. for 1 hour or until a homogenous mixture liquid was formed. The liquid was cooled, and 1.49 g water was added and mixed well, forming Part A. To a vial, 6.4 g of Part A, 3.2 g of pMDI (Part B) (2:1 Part A: Part B) and 0.058 g of triethanolamine were added. The contents were mixed for 1 min, forming an adhesive composition (detailed in Table 4, below).

TABLE 4

| Component | % |
|---|---|
| Diformyl Xylose | 31.19 |
| Novolac P15847 | 25.98 |
| Propylene Carbonate | 8.00 |
| Water | 1.10 |
| pMDI | 33.13 |
| Triethanolamine | 0.60 |

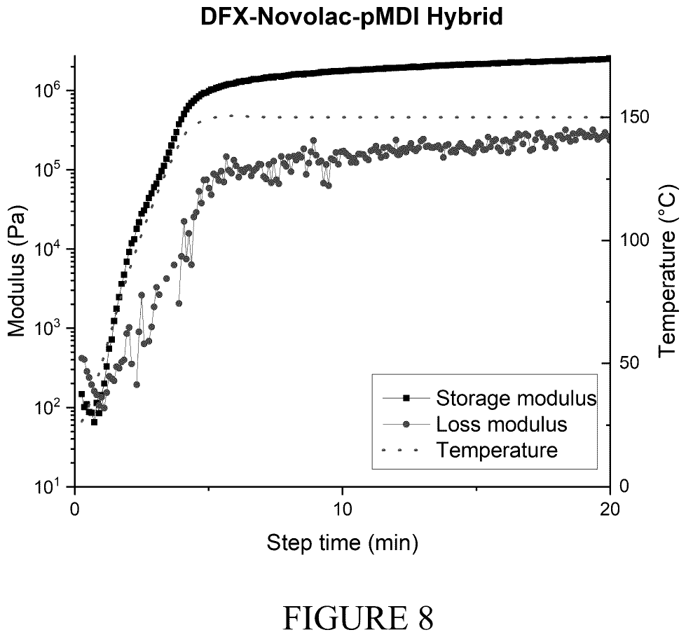

The viscosity of the mixture increased while in the vial and was immediately loaded on a rheometer and measurements were taken within 4 minutes of the start of mixing to determine the modulus as a function of time at a 150° C. temperature hold in an environmental test chamber (“ETC”). Oscillatory measurement was done on a TA HR-10 rheometer equipped with ETC (Environmental Test Chamber) with a liquid nitrogen cooling attachment, using 25 mm disposable stainless steel parallel plate geometry. The Oscillatory measurement frequency was set to 1 Hz and 0.05% strain amplitude. Upon mixing the 2-part system, samples were immediately loaded onto 25 mm stainless steel parallel plates and heated to 125° C. The samples were held in isothermal at 125° C. unless otherwise specified. Sampling rate was set to maximize the number of points. As illustrated in FIG. 8, the crossover point was 1 min, and the storage modulus increased to 2.5 MPa in 20 min.

### Example 9—Liquid Novolac resin and pMDI Hybrid System (No catalyst)—Eutectic Mixture

42.37 g of diformyl xylose (DFX), 35.29 g of novolac (Plenco 15847) (1.2:1 DFX to Novolac) and 10.86 g of propylene carbonate were added to a glass jar and put in oven at 130° C. for 1 hour or until a homogenous mixture liquid was formed. The liquid was left to cool down, and 1.49 g water was added to it and mixed well (“Part A”). 5.32 g of Part A, and 3.2 g of pMDI (“Part B”) (1.66:1 Part A: Part B) were then added to a vial. The composition of the mixture is illustrated in Table 5, below. The mixture was blended for 1 min, and the mixture was immediately loaded on rheometer and the measurements were initiated within 5 min of the start of mixing to study the modulus as a function of time at 150° C. temperature hold in ETC chamber.

TABLE 5

| Component | % |
|---|---|
| Diformyl Xylose | 29.39 |
| Novolac P15847 | 24.48 |
| PC | 7.53 |
| Water | 1.03 |
| pMDI | 37.56 |

Oscillatory measurement was done on a TA HR-10 rheometer equipped with ETC (Environmental Test Chamber) with a liquid nitrogen cooling attachment, using 25 mm disposable stainless steel parallel plate geometry. The oscillatory measurement frequency was set to 1 Hz and 0.05% strain amplitude. Upon mixing the 2-part system, samples were immediately loaded onto 25 mm stainless steel parallel plates and heated to 150° C. The samples were held isothermal at 125° C. Sampling rate was set to maximize the number of points.

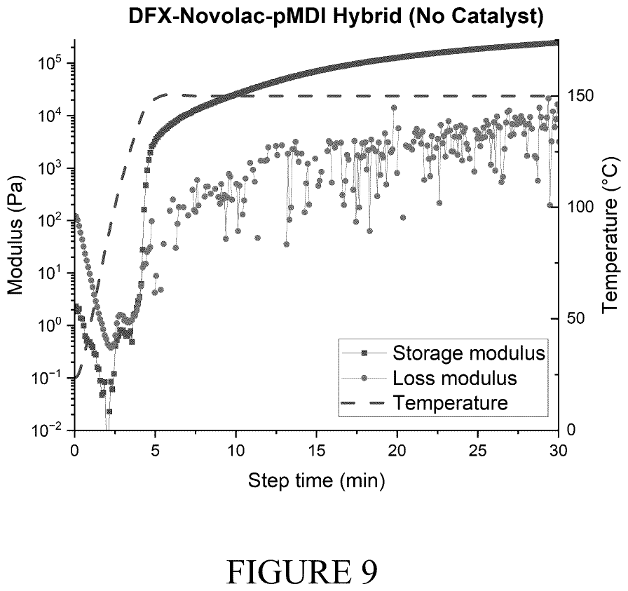

As illustrated in FIG. 9, the crossover point was 3.66 min, and the storage modulus increased to 0.13 MPa in 20 min and 0.24 MPa at the end of 30 min.

### Example 10—DFP-Novolac Resin and pMDI Hybrid System (with TEA catalyst)—Eutectic Mixture

42.59 g of diformyl pentaerythritol (DFP), 35.47 g of novolac (Plenco 15847) (1.2:1 DFP to novolac) and 9.78 g of propylene carbonate were added to a glass jar and put in oven at 130° C. for 3 hours or until a homogenous mixture liquid was formed. The liquid was cooled, and 1.48 g water was added and mixed well (“Part A”). To a vial, 6.4 g of Part A, 3.2 g of pMDI (“Part B”) (2:1 Part A: Part B), and 0.049 g of triethanolamine were added. The contents were mixed for 1 min. The composition of the mixture is illustrated in Table 6, below.

TABLE 6

| Component | % |
|---|---|
| Diformyl | 31.64 |
| Pentaerythritol | |
| Novolac P15847 | 26.35 |
| Propylene Carbonate | 7.27 |
| Water | 1.10 |
| pMDI | 33.14 |
| Triethanolamine | 0.51 |

The viscosity of the mixture increased while in the vial and was immediately loaded on a rheometer and measurements were taken within 4 min of the start of mixing to study the modulus as a function of time at a 150° C. temperature hold in an ETC chamber. Oscillatory measurement was done on a TA HR-10 rheometer equipped with ETC (Environmental Test Chamber) with a liquid nitrogen cooling attachment, using 25 mm disposable stainless steel parallel plate geometry. The oscillatory measurement frequency was set to 1 Hz and 0.05% strain amplitude. Upon mixing the 2-part system, samples were immediately loaded onto 25 mm stainless steel parallel plates and heated to 150° C. Sampling rate was set to maximize the number of points.

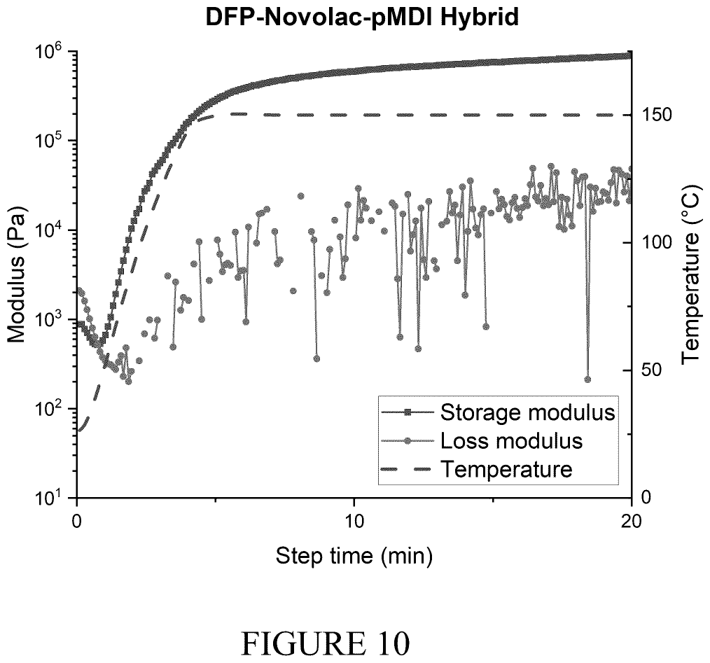

As illustrated in FIG. 10, the crossover point was 45 seconds and the storage modulus increased to 0.9 MPa in 20 min.

### Example 11—Rheology

Liquid adhesive compositions (Examples 11-1-11-7) were prepared as described below in Table 7. The viscosity was measured to be 4270 cP using a rheometer with 25 mm parallel plates, a 0.6 mm gap, and an angular velocity of 0.33 rad/s. Examples 11-2 and 11-4 to 11-7 formed eutectic mixtures.

Oscillatory rheology tests were performed on the samples to observe the curing of the solutions at an elevated temperature. Rheology oscillatory data was collected on a TA HR-10 rheometer equipped with ETC (Environmental Test Chamber) with a liquid nitrogen cooling attachment, using 25 mm disposable stainless steel parallel plate geometry. The oscillatory test method frequency was set to 1 Hz and 0.05% strain amplitude. Upon mixing the 2-part system, samples were immediately loaded onto 25 mm stainless steel parallel plates and heated to 125° C. and held isothermal at 125° C. unless otherwise specified. Sampling rate was set to maximize number of points.

TABLE 7

| | | | | | Hardener | | Storage |
|---|---|---|---|---|---|---|---|
| | | | | | (wt. %) | | mod. at |
| | Resin | Acetal | Water | | (70% | Crossover | Crossover |
| | (wt. %) | (wt. %) | (wt. %) | Additive | pTSA) | Time (min) | (MPa) |
| 11-1 | 35% Plenco | 35% | 1.11% | 18.89% PC | 10% | 1.56 | 0.0001295 |
| | 14845 | DFG | | | | | |
| 11-2 | 30% Plenco | 60% | 2.86% | — | 7.14% | 3.44 | 0.0000433 |
| | 14845 | DFP | | | | | |
| 11-3 | 30% Plenco | 60% | 2.86% | — | 7.14% | 2.52 | 0.0005333 |
| | 14845 | glycerol | | | | | |
| | | formal | | | | | |
| 11-4 | 35.79% | 28.63% | — | 29.46% PC | 7.13% | 3.09 | 0.0000189 |
| | Plenco 14845 | DFP | | | | | |
| 11-5 | 37.15% | 44.58% | — | 11.17% PC | 7.1% | 3.47 | 0.0005416 |
| | Plenco 14845 | DFP | | | | | |
| 11-6 | 30% Plenco | 60% | — | — | 10% | 2.6 | 0.0000171 |
| | 14845 | DFX | | | | | |
| 11-7 | 37.16% | 55.71% | — | — | 7.13% | 3.28 | 0.0000656 |
| | Plenco 14845 | DFP | | | | | |
| 11-8 | 32.14% | 32.14% | 2.86% | 25.71% | 7.14% | 2.91 | 0.0000601 |
| | Plenco 14845 | glycerol | | glycerol | | | |
| | | formal | | carbonate | | | |

### Example 12—Wood Gluing Samples

Liquid adhesive compositions (Samples 12-1 to 12-18) were prepared as described below in Table 8. For each sample, the crosslinking agent and resin were melted at 130° C. and blended together. The mixture was cooled to 90° C. and any water or other optional additives were included. The catalyst was then mixed for one minute before gluing the wood panels. Examples 12-2 and 12-4 to 12-18 formed eutectic mixtures.

Sample 12-12 includes unwashed diformyl xylose (DFX), which was synthesized by adding 289.1 g of D-xylose, 144.5 g of paraformaldehyde, 453.83g of 2-methyl THF, and 33.18g of 97.7% sulfuric acid to a reaction flask and reacting for 4 hours. The flask contents were cooled to 35° C., and 53.66g of 50% NaOH in water was charged to the reaction flask to neutralize. The reaction flask was then heated to 50° C., under vacuum, to remove 2-Me THF. 30 g of ethyl acetate was charged to the flask, and distillation was continued at 55° C., until no more distillate was being collected. 374 g of unwashed DFX product was recovered from the reaction flask.

TABLE 8

| | | | | | Hardener | | | AVG | |
|---|---|---|---|---|---|---|---|---|---|
| | | Crosslinking | | | (wt. %) | | Press | Break | |
| | Resin | Agent | Water | | (70% aq. | Wood | Temp/Time | Load | AVG % |
| | (wt. %) | (wt. %) | (wt. %) | Additive | pTSA) | Species | ° C./min | (psi) | WF |
| 12-1 | 30% | 60% | 2.86% | — | 7.14% | Poplar | 125/4 | 250 | 23 |
| | Plenco | glycerol | | | | | | | |
| | 14845 | formal | | | | | | | |
| 12-2 | 30% | 60% DFP | 2.86% | — | 7.14% | Poplar | 125/4.5 | 127 | 28 |
| | Plenco | | | | | | | | |
| | 14845 | | | | | | | | |
| 12-3 | 32.14% | 32.14% | 2.86% | 25.71% | 7.14% | Poplar | 125/5 | 257 | 28 |
| | Plenco | glycerol | | glycerol | | | | | |
| | 14845 | formal | | carbonate | | | | | |
| 12-4 | 37.16% | 55.71% | — | — | 7.13% | Poplar | 125/5 | 137 | 62 |
| | Plenco | DFP | | | | | | | |
| | 14845 | | | | | | | | |
| 12-5 | 37.15% | 44.58% | — | 11.17% | 7.1% | Poplar | 125/5 | 157 | 70 |
| | Plenco | DFP | | | | | | | |
| | 14845 | | | | | | | | |
| 12-6 | 29.7% | 59.4% | — | 1% | 9.9% | Poplar | 125/4 | 150 | 82 |
| | Plenco | DFX | | sodium | | | | | |
| | 14845 | | | bisulfite | | | | | |
| 12-7 | 29.7% | 59.4% | — | 1% | 9.9% | Poplar | 125/4 | 140 | 90 |
| | Plenco | DFX | | imidazole- | | | | | |
| | 14845 | | | done | | | | | |
| 12-8 | 36.25% | 43.5% | — | | 10% | Southern | 150/5 | 127 | 90 |
| | Plenco | DFX + | | | | Yellow | | | |
| | 14845 | 10.26% | | | | Pine | | | |
| | | glycerol | | | | | | | |
| | | formal | | | | | | | |
| 12-9 | 36.25% | 43.5% | — | 10.26% | 10% | Southern | 150/2 | 240 | 89 |
| | Plenco | DFX | | glycerol | | Yellow | | | |
| | 14845 | | | carbonate | | Pine | | | |
| 12-10 | 35.79% | 42.96% | 3.11% | 11% PC | 7.14% | Poplar | 150/3 | 307 | 92 |
| | Plenco | DFX | | | | | | | |
| | 15847 | | | | | | | | |
| 12-11 | 32.34% | 38.82% | 8% | 13.5% PC + | 7.14% | Poplar | 150/3 | 290 | 75 |
| | Plenco | DFX | | 0.2% | | | | | |
| | 15847 | | | Surfanol | | | | | |
| | | | | 104H | | | | | |
| 12-12 | 30.27% | 42.74% | 4.17% | 12.63% | 10% | Poplar | 130/3 | 137 | 83 |
| | Plenco | unwashed | | PC | | | | | |
| | 15847 | DFX | | | | | | | |
| 12-13 | 30% | 60% DFX | — | — | 10% | Poplar | 150/3 | 157 | 93 |
| (10-5) | Plenco | | | | | | | | |
| | 14845 | | | | | | | | |
| 12-14 | 36.36% | 43.64% | | 10% | 10% | Poplar | 150/3 | 173 | 93 |
| | Plenco | DFX | | cyrene | | | | | |
| | 14845 | | | | | | | | |
| 12-16 | 36.4% | 43.64% | 5% | 10% PC | 5% | Poplar | 150/3 | 230 | 95 |
| | Plenco | DFX | | | (solid) | | | | |
| | 14845 | | | | | | | | |
| 12-17 | 25.67% | 53.33% | — | 10% PC | 5% | Poplar | 150/3 | 180 | 92 |
| | Plenco | DFX | | | (62.2% in | | | | |
| | 14845 | | | | water) | | | | |
| 12-18 | 35.34% | 42.41% | 4% | 10% PC + | 6.25% | Poplar | 150/3 | 253 | 95 |
| | Plenco | DFX | | 2% 2′- | (80% in | | | | |
| | 14845 | | | hydroxy- | water) | | | | |
| | | | | acetephenone | | | | | |
| 12-19 | 40% | 40% DFG | 1.11% | 10% PC | 8.89% | Poplar | 124/4 | 187 | 98 |
| | Plenco | | | | | | | | |
| | 14845 | | | | | | | | |

DFG = diformyl glucose acetal
DFX = diformyl xylose
DFP =diformyl pentaerythritol
PC = propylene carbonate

As illustrated above, each of the wood samples demonstrated successful gluing in the press. Samples 12-1 to 12-5 consolidated in the press to form a laminated plywood composite. Although these samples consolidated, they demonstrated low % WF performance, due to the influence of low acid catalyst concentration. This suggests the possibility of incomplete cure. When the catalyst loading was increased, the Samples all showed acceptable WF % and average (AVG) breaking loads. The increased catalyst loading allowed for thorough cure within the given press time.

### Example 13—Particleboard Examples

### Example 13.1. DFX-Novolac Powder in Wood Composite Application

A DFX-novolac powder was prepared by blending 20 g of Plenco 14845 with 20 g of DFX. A zinc chloride solution was prepared by adding 0.107 g of zinc chloride to 0.249 g of water. The solution was added dropwise to 29.38 g of poplar wood furnish and blended for 15 minutes. 1.417 g of the DFX-novolac powder was added to the poplar furnish and blended for an additional 5 minutes. The resulting furnish blend contained 5% DFX-novolac powder by solid mass and 9% water content, as described in Table 9. The furnish blend was pressed in a 4-inch×4 in metal guide, to a height of 0.135 in, for 10 minutes at 149° C.

TABLE 9

| | Example A | | | | | |
|---|---|---|---|---|---|---|
| | 5% 1:1 DFX/Novolac w 0.377% ZnCl2 | | | | | |
| | | Solid | | Added | | |
| | % Solid | Mass | % MC of | Mass | Added | |
| Component | Mass | (g) | Material | (g) | Mass % | % Water |
| Poplar | 94.62% | 26.825 | 8.7% | 29.38 | 94.31% | 8.20% |
| Furnish | | | | | | |
| Water | 0% | 0.000 | 100% | 0.249 | 0.80% | 0.80% |
| ZnCl2 | 0.377% | 0.107 | 0% | 0.107 | 0.34% | 0.00% |
| DFX/Novolac | 5.00% | 1.417 | 0% | 1.417 | 4.55% | 0.00% |
| TOTAL | 100.00% | 28.350 | — | 31.15 | 100.00% | 9.00% |

The resulting samples were cut to a length and width of 59.7 mm×12.8 mm and tested by dual cantilever DMA at 25C, 1 Hz, and a 5 μm amplitude. The resulting storage modulus is reported in Table 10.

TABLE 10

| Sample | Storage Modulus (GPa) | Density (lb/ft3) |
|---|---|---|
| Example A | 0.63 | 42.55 |
| Example B | 0.257 | 48.03 |
| Polystyrene Plastic Reference | 0.82 | 63.66 |

### Example 13.2. DFX-Novolac Powder in Wood Composite Application

A DFX-novolac powder was prepared by blending 20 g of Plenco 14845 with 20 g of DFX. A zinc chloride solution was prepared by adding 0.064 g of zinc chloride to 0.19 g of water. The solution was added dropwise to 30.05 g of poplar wood furnish and blended for 15 minutes. 0.850 g of the DFX-novolac powder was added to the poplar furnish and blended for an additional 5 minutes. The resulting furnish blend contained 3% DFX-novolac powder by solid mass and 9% water content, as described in Table 11. The furnish blend was pressed in a 4-inch×4 in metal guide, to a height of 0.135 in, for 10 minutes at 149° C.

TABLE 11

| | Example B | | | | | |
|---|---|---|---|---|---|---|
| | 3% 1:1 DFX/Novolac w 0.266% ZnC12 | | | | | |
| | | Solid | | Added | | |
| | % Solid | Mass | % MC of | Mass | Added | |
| Component | Mass | (g) | Material | (g) | Mass % | % Water |
| Furnish | 96.77% | 27.435 | 8.7% | 30.05 | 96.45% | 8.39% |
| Water | 0% | 0.000 | 100% | 0.19 | 0.61% | 0.61% |
| ZnCl2 | 0.226% | 0.064 | 0% | 0.064 | 0.21% | 0.00% |
| DFX/Novolac | 3.00% | 0.850 | 0% | 0.850 | 2.73% | 0.00% |
| TOTAL | 100.00% | 28.350 | — | 31.15 | 100.00% | 9.00% |

The resulting samples were cut to a length and width of 59.7 mm×12.8 mm and tested by dual cantilever DMA at 25C, 1 Hz, and a 5 μm amplitude. The resulting storage modulus is reported above in Table 10.

### Example 14—Adhesive for Metal Gluing Samples 14-1 to 14-7—Eutectic Mixtures

DFX-Novolac adhesive was prepared by heating 35.02 g of diformyl xylose (DFX) to 70° C. and held at this temperature until melted. Once the DFX melted, 17.45 g of Plenco 14845 was added and heated until it fully dissolved. After the novolac dissolved, 5.54 g of water was added and mixed until homogenized. After homogenization, the liquid adhesive mixture was cooled to 25° C.

Metal coupons were washed in warm soapy water, rinsed, then washed with denatured ethanol (200 proof). Metal substrates were allowed to dry at ambient temperature. The coupons were assembled into coupon assemblies for gluing. Next, the 2-part liquid novolac formulation was prepared by mixing 9 parts liquid novolac with 1 part 70% aqueous pTSA solution and mixed to ensure homogenization. The target spread rate was 30 lbs per 1000 ft². Assemblies were pressed at 100 psi and hot pressed for 5 minutes at 125° C. Samples were then tested according to ASTM D-1002 for tensile strength. The resulting tensile breaking loads are reported in Table 12 below. Sample 14-7 demonstrated non-ideal performance compared to Samples 14-1 to 14-6. This was due to application error.

TABLE 12

| Specimen | Breaking |
|---|---|
| # | Loads (psi) |
| 14-1 | 54.61 |
| 14-2 | 61.29 |
| 14-3 | 59.55 |
| 14-4 | 53.21 |
| 14-5 | 48.33 |
| 14-6 | 59.92 |
| 14-7 | 4.25 |
| Average | 48.74 |

What is claimed is:

1. An adhesive composition comprising a eutectic mixture of:
a novolac resin; and
a cyclic acetal crosslinking agent selected from the group consisting of diformylxylose, diformyl pentaerythritol, or mixtures thereof.

2. The adhesive composition of claim 1, wherein the adhesive composition is a liquid and has a viscosity at 25° C. of 100 to 10,000 cP.

3. The adhesive composition of claim 1, wherein the eutectic mixture has a melting point between 60° C. and 70° C.

4. The adhesive composition of claim 1, wherein the adhesive composition is a solid adhesive composition.

5. The adhesive composition of claim 1, wherein the adhesive composition further includes a processing aid selected from the group consisting of water, methanol, ethanol, glycerin, ethylene glycol, propylene glycol, dihydrolevoglucosenone, levoglucosenone, dipropylene glycol dibenzoate, diethylene glycol dibenzoate, propylene carbonate, glycerol carbonate, triethyl citrate, and combinations thereof.

6. The adhesive composition of claim 5, wherein the processing aid is present in the adhesive composition in an amount from 0.1 wt. % to 40 wt. %, based on a total weight of the adhesive composition.

7. The adhesive composition of claim 1, wherein the adhesive composition comprises:
1 wt. % to 99 wt. % of the novolac resin; and
1 wt. % to 99 wt. % of the cyclic acetal crosslinking agent, based on a total weight of the adhesive composition.

8. The adhesive composition of claim 1, wherein the novolac resin and cyclic acetal crosslinking agent are present in the adhesive composition in a weight ratio of about 5:1 to about 0.25:2.5.

9. The adhesive composition of claim 1, further comprising an acid catalyst.

10. The adhesive composition of claim 9, wherein the acid catalyst has a pKa no greater than 6.

11. The adhesive composition of claim 9, wherein the acid catalyst is selected from the group consisting of sulfuric acid, formic acid, glyoxylic acid, citric acid, hydrochloric acid, Lewis acid, zinc chloride, aluminum chloride, phosphoric acid, alkane sulfonic acid, p-toluenesulfonic acid, methanesulfonic acid, benzoic acid, and combinations thereof.

12. The adhesive composition of claim 1, further comprising at least one additional component selected from the group consisting of polar solvents, non-polar solvents, formaldehyde scavengers, plasticizers, rheology modifiers, fillers, flame retardants, lubricants, softening agents, pigments, biocides, latent acid donors such as acid anhydrides and/or alkyl esters, surfactants, latexes, hydrophobic agents, waxes, and combinations thereof.

13. The adhesive composition of claim 1, wherein the composition has a curing temperature from 100° C. to 150° C.

14. The adhesive composition of claim 1, wherein the composition further includes an isocyanate and is free of an acid catalyst.

15. The adhesive composition of claim 14, wherein the composition includes a novolac resin; and a cyclic acetal crosslinking agent selected from the group consisting of diformylxylose (“DFX”), diformyl pentaerythritol (“DFP”), and mixtures thereof; and pMDI.

16. A method of manufacturing a liquid adhesive composition comprising:
dissolving a novolac powder in a eutectic solvent, optionally in the presence of a processing aid, wherein the eutectic solvent is selected from the group consisting of diformylxylose (“DFX”), diformyl pentaerythritol (“DFP”), or mixtures thereof; and
cooling the liquid to room temperature.

17. The method of claim 16, further comprising the step of adding an acid catalyst to the liquid adhesive composition after the step of cooling.

18. The method of claim 16, wherein the composition further includes an isocyanate and is free of an acid catalyst.

19. The method of claim 18, wherein the composition includes a novolac resin; and a cyclic acetal crosslinking agent selected from the group consisting of diformylxylose (“DFX”), diformyl pentaerythritol (“DFP”), and mixtures thereof; and pMDI.

20. A composite article formed with the adhesive composition of claim 1.

21. The composite article of claim 20, wherein the composite article comprises plywood, a laminated veneer layer (LVL) product, laminated glulam beam, mass timber, oriented strand board (OSB), cross-laminated timber (CLT), particle board, medium density fiberboard (MDF), saturated paper, paper laminate, fiberglass, metal, or combinations thereof.
